(19) United States
(12) Patent Application Publication
(10) Pub. No.: US 2023/0246924 A1
(43) Pub. Date: Aug. 3, 2023

(54) AUTOMATIC CANVAS CREATION ASSOCIATED WITH A GROUP-BASED COMMUNICATION CHANNEL

(71) Applicant: salesforce.com, inc., San Francisco, CA (US)

(72) Inventors: Sohom Paul, Sugarland, TX (US); Michael Hahn, San Francisco, CA (US)

(21) Appl. No.: 17/649,507

(22) Filed: Jan. 31, 2022

(51) Int. Cl. H04L 41/22; G06F 3/0482; G06F 3/0484

(52) U.S. Cl. CPC H04L 41/22; G06F 3/0482; G06F 3/0484

(57) ABSTRACT

Methods, systems, apparatuses, devices, and computer program products are described. A group-based communication platform may support creation of a group-based communication channel, for example, by a user. Creating the channel may trigger creation of a corresponding canvas (e.g., a channel about page) associated with the channel. The channel may include a sequential listing of messages and the canvas, where the canvas includes one or more information blocks (e.g., auto-generated with the canvas). The information blocks may be editable by users accessing the channel, and the canvas may be viewed concurrently with the channel contents in a user interface. The information blocks may include at least an information block configured to track activity associated with objects in the channel. If the group-based communication platform detects activity in the channel, the platform may automatically trigger updating the information block configured to track the activity in order to reflect the detected activity.

### TECHNICAL FIELD

The present disclosure relates generally to communication systems and data processing, and more specifically to automatic canvas creation associated with a group-based communication channel.

A cloud platform (e.g., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

Users may communicate information using a communication platform (e.g., separate from or associated with the cloud platform). In some examples, the communication platform may support different groups of users sharing content within specific channels. However, the purpose of a specific channel may be unclear to a user of the channel or a user outside the channel. Additionally or alternatively, sharing high-level information about a channel within messages in the channel may reduce searchability of the channels and otherwise obfuscate important information from users.

### SUMMARY

The described techniques relate to improved methods, systems, devices, and apparatuses that support automatic canvas creation associated with a group-based communication channel. A group-based communication platform may support creation of a group-based communication channel, for example, by a user. Creating the channel may trigger creation of a corresponding canvas (e.g., a channel about page) associated with the channel. The channel may include channel contents, such as a sequential listing of messages, and the canvas, where the canvas may include one or more information blocks auto-generated with the canvas or added by a user. For example, the information blocks may be editable by multiple users accessing the channel. Additionally or alternatively, the canvas and the channel contents may be viewed concurrently within a user interface. The information blocks may include at least an information block configured to track activity associated with objects (e.g., messages, files, users) in the channel. If the group-based communication platform detects activity in the channel (e.g., a user posting a message, a user sharing a file, a member being added to the channel, or any other activity related to the channel), the group-based communication platform may automatically trigger an update to the information block configured to track the channel activity. The triggered update may allow the information block to reflect the detected activity and maintain synchronization with the current state of the corresponding channel. The group-based communication platform may send the canvas with the updated information block for display in a user interface of a user device.

The techniques described herein may improve the usability, functionality, and user experience of a group-based communication channel in a group-based communication platform. For example, the generated canvas may include a summary description for the corresponding channel. This summary description, as well as the rest of the canvas, may be editable by multiple users accessing the channel, such that the summary description may be easily revised by one or more users. The summary description in the canvas may also be searchable, improving the search functionality of the group-based communication platform. For example, users may search for channels that they previously have not accessed by using the channel summary descriptions in the canvases. Additionally or alternatively, the search results may be weighted to highlight results corresponding to a summary description of a channel. In some examples, the canvas may track activities performed in the group-based communication channel, providing users with additional information about how a channel is changing over time. By tracking and displaying these activities, the canvas may allow users to determine changes to a channel and quickly view the changes to the channel. Further, the canvas may provide access to workflows, data objects, or both directly in the canvas, allowing a user to perform data processing associated with a channel while concurrently viewing the canvas and the channel contents within a shared user interface. The canvas corresponding to the channel may display dynamic information relating to the channel and may provide an interface in which users can highlight important aspects of the channel, perform operations associated with the channel, link to related information, or the like to improve the user experience and functionality of a group-based communication platform.

### BRIEF DESCRIPTION OF THE DRAWINGS

FIG. 1 illustrates an example of a system that supports automatic canvas creation associated with a group-based communication channel in accordance with aspects of the present disclosure.

FIG. 2 illustrates an example of a group-based communication system that supports automatic canvas creation associated with a group-based communication channel in accordance with aspects of the present disclosure.

FIGS. 3 through 6B illustrate examples of user interfaces that support automatic canvas creation associated with a group-based communication channel in accordance with aspects of the present disclosure.

FIG. 7 illustrates an example of a process flow that supports automatic canvas creation associated with a group-based communication channel in accordance with aspects of the present disclosure.

FIG. 8 shows a block diagram of an apparatus that supports automatic canvas creation associated with a group-based communication channel in accordance with aspects of the present disclosure.

FIG. 9 shows a block diagram of a channel manager that supports automatic canvas creation associated with a group-based communication channel in accordance with aspects of the present disclosure.

FIG. 10 shows a diagram of a system including a device that supports automatic canvas creation associated with a group-based communication channel in accordance with aspects of the present disclosure.

FIGS. 11 and 12 show flowcharts illustrating methods that support automatic canvas creation associated with a group-based communication channel in accordance with aspects of the present disclosure.

### DETAILED DESCRIPTION

A group-based communication platform may support multiple group-based communication channels. A group-based communication channel may provide a virtual space in which users of a group may communicate, for example, by posting messages, entering hangout meetings, performing calls, sharing files, or communicating using any other means. In some systems, an organization (e.g., a tenant of a multi-tenant database system or another organization) may use multiple different channels within the group-based communication platform. For an organization with a significant number of channels (e.g., tens, hundreds, or thousands of channels), searching channels, navigating between channels, and determining the purposes of channels may introduce significant complexity or latency. Additionally, a user with membership to a significant number of channels may miss changes or important posts within one of the channels, resulting in inefficiencies or otherwise poor reliability.

Techniques described herein may support automatic creation of a canvas associated with a channel in a group-based communication platform to provide additional functionality and improved usability for the corresponding channel. The group-based communication platform may support creation of a group-based communication channel, for example, by a user. Creating the channel may automatically trigger creation of a corresponding canvas (e.g., a channel about page) associated with the channel. The canvas may include one or more information blocks auto-generated with the canvas, added by a user, or both. For example, the information blocks may be editable by multiple users accessing the channel, and the canvas may be viewed concurrently with the contents of the channel (e.g., a sequential listing of messages) in a user interface. The information blocks may include at least an information block configured to track activity associated with objects in the channel. If the group-based communication platform detects activity in the channel, the platform may automatically trigger updating the information block configured to track the activity in order to indicate the detected activity within the canvas. Additionally or alternatively, the canvas may include a searchable and editable summary description for the channel, a workflow that can be executed within the canvas, a data object accessed in an external source and displayed within the canvas, a pin to content in the channel, a bookmark of content in the channel, or any combination of these or other objects for display in the canvas. The canvas may be configurable (e.g., by multiple users) and may dynamically update to indicate a current state of the corresponding channel, the underlying data (e.g., from a database system), or both.

Aspects of the disclosure are initially described in the context of an environment supporting an on-demand database service and an environment supporting a group-based communication system. Additional aspects of the disclosure are described with reference to user interfaces, for example, associated with a group-based communication platform. Aspects of the disclosure are further illustrated by and described with reference to apparatus diagrams, system diagrams, and flowcharts that relate to automatic canvas creation associated with a group-based communication channel.

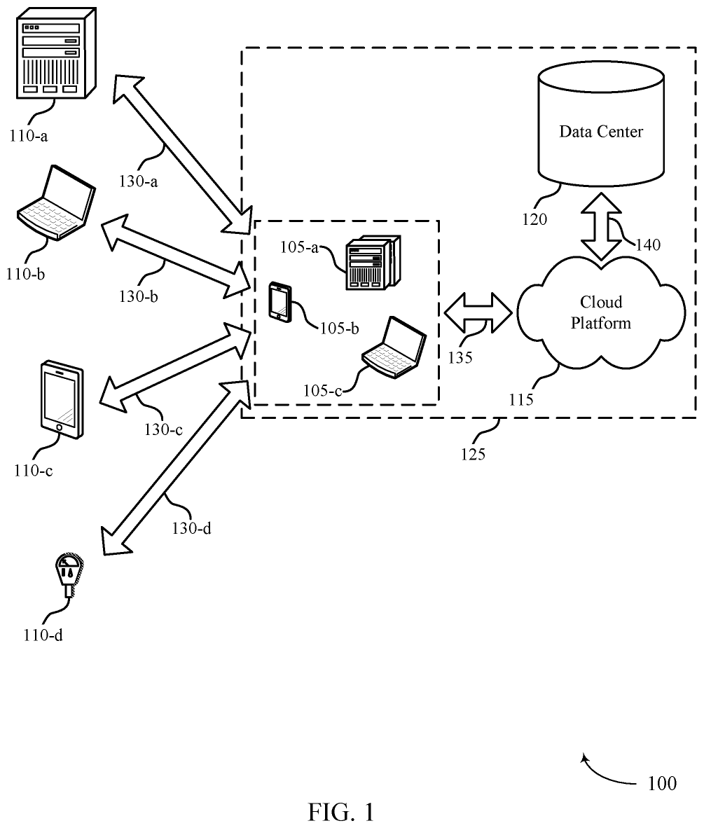

FIG. 1 illustrates an example of a system 100 that supports automatic canvas creation associated with a group-based communication channel in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support customer relationship management (CRM) solutions. This may include support for sales, service, marketing, community, analytics, applications, and the Internet of Things. Cloud platform 115 may receive data associated with contact interactions 130 from the cloud client 105 over network connection 135 and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

In some examples, the system 100 may further support a group-based communication system. For example, a group-based communication system may provide a platform for users to communicate within groups defined by group-based communication channels. The group-based communication system may leverage one or more aspects of the subsystem 125. For example, data objects stored in the data center 120, the cloud platform 115, or both may be accessed or otherwise referenced within a channel of the group-based communication system. Additionally or alternatively, the cloud platform 115 may support a group-based communication platform.

A group-based communication platform may support automatic creation of a canvas corresponding to a channel (e.g., a group-based communication channel). The channel may include a sequential listing of messages and the canvas, where the canvas includes one or more information blocks (e.g., auto-generated with the canvas). The information blocks may be editable by users accessing the channel, and the canvas may be viewed concurrently with the channel contents in a user interface (e.g., of a user device, such as a cloud client 105 or contact 110). The canvas may provide a summary or description of the corresponding channel. Additionally, the information blocks may include at least an information block configured to track activity associated with objects in the channel. If the group-based communication platform detects activity in the channel, the platform may automatically trigger updating the information block configured to track the activity in order to reflect the detected activity.

Some other systems implement a summary description of a communication channel. However, this summary description may be static. Additionally, such a summary may fail to indicate important information or updates within the channel and may fail to provide any further functionality to the channel.

In contrast, the system 100 may support a group-based communication platform that automatically generates a canvas upon channel creation to indicate a summary description of the channel. This summary description, as well as the rest of the canvas, may be editable by multiple users accessing the channel. Additionally, the canvas may track activities performed in the group-based communication channel, providing users with additional information about how a channel is changing over time. Further, the canvas may provide access to workflows, data objects, or both directly in the canvas, allowing a user to perform data processing associated with the channel while concurrently viewing the canvas and the channel contents within a shared user interface. The canvas may improve the search functionality of the group-based communication platform by searching the canvas channel summaries or weighting results based on identifying a search term in a canvas channel summary. By associating a canvas with a corresponding channel, the canvas may display dynamic information relating to the channel and may provide an interface in which users can highlight important aspects of the channel, perform operations associated with the channel, link to related information, or the like.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

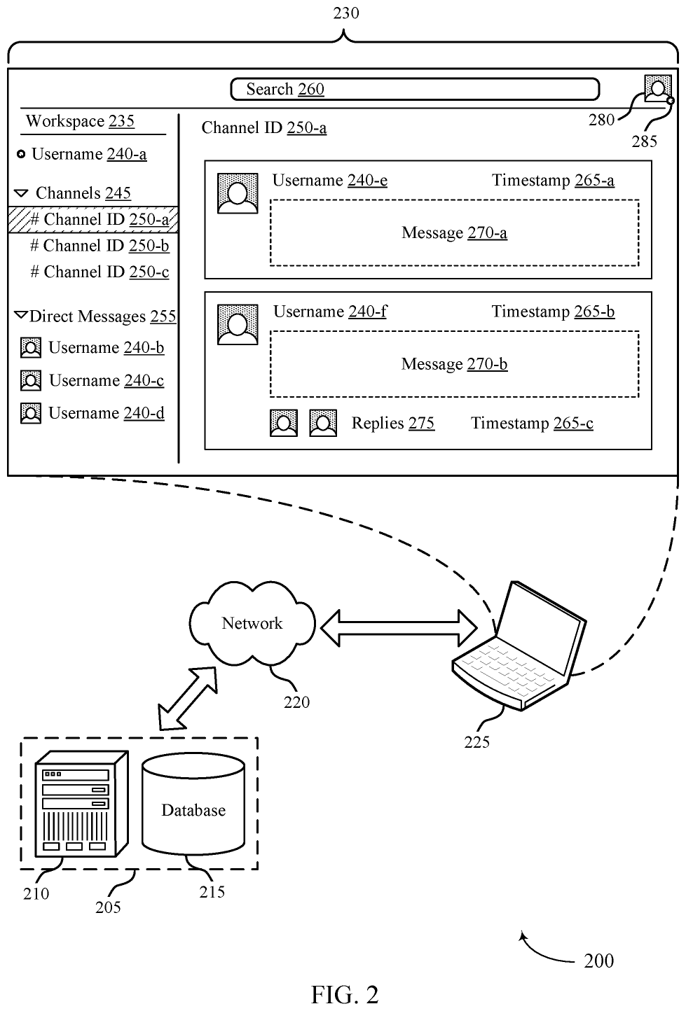

FIG. 2 illustrates an example of a group-based communication system 200 that supports automatic canvas creation associated with a group-based communication channel in accordance with aspects of the present disclosure. The group-based communication system 200 may be implemented as part of or with a system 100. For example, the group-based communication system 200 may leverage data stored at a cloud platform 115, a data center 120, or some combination thereof. The group-based communication system 200 may include a group-based communication platform 205 hosted by one or more computing devices 210, databases 215, or a combination thereof. The group-based communication system 200 may support displaying data to a user via a user interface 230 of a user device 225. In some examples, the user device 225 may communicate with the group-based communication platform 205 via a network 220. In some cases, the user device 225 may be an example of a cloud client 105 or a contact 110 in a system 100, as described with reference to FIG. 1.

The group-based communication platform 205 may leverage a network-based computing system to enable users of the group-based communication platform 205 to exchange data. By being “group-based,” the platform may support communication channels, messages, virtual spaces, or a combination thereof organized into groups of users. The group-based communication platform 205 may include security policies or features that define access to resources (e.g., channels, messages) according to such groups. In some examples, the groups of users may be defined by group identifiers (IDs), which may be associated with common access credentials, domains, or the like. In some examples, the group-based communication platform 205 may provide a virtual space enabling users to chat, meet, call, collaborate, transfer files or other data, or otherwise communicate within groups. In some examples, a group may be associated with a workspace 235, enabling users associated with the group to communicate within the group in a secure and private virtual space. In some cases, members of a group or a workspace may be associated with a same organization (e.g., a tenant of a multi-tenant database system). In some other cases, members of a group or a workspace may be associated with different organizations (e.g., entities with different organization IDs, such as different tenants in a multi-tenant database system).

One or more computing devices 210 may support the group-based communication platform 205. For example, the one or more computing devices 210 may include an application server, a database server, a cloud-based server or service, a worker server, a server cluster, a virtual machine, a container, or any combination of these or other computing devices supporting data processing. For example, the one or more computing devices 210 may include one or more processors, memory, computer-readable media, or a combination thereof. The one or more computing devices 210 may perform functions and provide features as described herein with respect to the group-based communication platform 205. The group-based communication platform 205 may further include one or more databases 215, which may include cloud-based data storage, physical data storage, or both. In some cases, the one or more databases 215 may be memory components of the one or more computing devices 210. The one or more databases 215 may store data associated with the group-based communication platform 205. For example, the one or more databases 215 may include data relating to channels, users, workspaces 235, or any combination thereof, logs of messages 270, security information, or any other information relevant to the group-based communication platform 205.

A user may access the group-based communication platform 205 using a user device 225. The user device 225 may be an example of a laptop, a desktop computer, a smartphone, a tablet, a smart device, or any other device operated by a user and including a user interface 230. The user device 225 may communicate with the group-based communication platform 205, for example, via a network 220. The network 220 may be any type of communication network, such as a local area network or a wide area network, the Internet, a wireless network, a cellular network, a local wireless network, Wi-Fi, Bluetooth®, Bluetooth Low Energy (BLE), Near Field Communication (NFC), a wired network, or any combination of these or other networks. The network 220 may support proper network protocols for transferring data between the user device 225 and the group-based communication platform 205. For example, the user device 225, the group-based communication platform 205, or both may apply one or more security protocols (e.g., encryption) for securely transferring data over the network 220. In some cases, one or more aspects of the group-based communication platform 205 may be implemented at the user device 225. For example, the user device 225 may download an application corresponding to the group-based communication platform 205 and may store information relating to the group-based communication platform 205 locally at the user device 225. In some other examples, the user device 225 may access the group-based communication platform 205 in a web browser.

The user device 225 may include a user interface 230 that may display information relating to the group-based communication platform 205. Additionally, a user may interact with the user interface 230 to communicate with other users, view data, modify data, or otherwise perform actions associated with the group-based communication platform 205. The group-based communication platform 205 may support multiple group-based communication channels, and the user interface 230 may display information relating to a group-based communication channel corresponding to a channel ID 250-a. The user interface 230 may display a sidebar including navigation information for a user and a central pane (e.g., a main pane) including the channel contents, such as a sequential listing of messages 270 corresponding to the channel ID 250-a. A channel (e.g., a group-based communication channel) may provide a virtual space for a group of users to communicate via messages, hangouts, video or audio calls, files, or any other means of communication. The group of users may include members of the channel, non-members of the channel with access to the channel, or both.

A user may log into the group-based communication platform 205 (e.g., using a username 240-a, a password, or both). In response to the user logging in, the group-based communication platform 205 may send, for display in the user interface 230, data corresponding to the user. For example, the user may be associated with a specific workspace 235, a set of channels 245, a set of connections, a set of threads, a set of direct messages 255, or any combination of these. The user device 225 may retrieve or otherwise access the relevant information for the user (e.g., based on the username 240-a or another user ID) and surface the information for display in the user interface 230 according to a display format.

As an example, in a sidebar (e.g., a navigation pane), the user interface 230 may display an indication of a workspace 235 corresponding to the user and the username 240-a of the user. The sidebar may further include indications of a set of channels 245 using the respective channel IDs 250. For example, the set of channels 245 may include the channels to which the user is a member. As illustrated, the set of channels 245 may include a first channel corresponding to a first channel ID 250-a, a second channel corresponding to a second channel ID 250-b, and a third channel corresponding to a third channel ID 250-c. It is to be understood that the set of channels 245 may include any quantity of channels for selection by the user. The user may select a channel from the listing of the set of channels 245, and the user interface 230 may display the selected channel (e.g., the messages 270 associated with the selected channel) in the central pane. The sidebar may further include a set of direct messages 255 between the user with the username 240-a and one or more other users. For example, the set of direct messages 255 may include the usernames 240 (or nicknames) of the users communicating via direct messages with the user. In some examples, the list of users may include users added by the user with username 240-a, users who have current, ongoing direct message conversations with the user with username 240-a, or both. As illustrated, the set of direct messages 255 may include indications of a user with a first username 240-b, a user with a second username 240-c, and a user with a third username 240-d, although any quantity of users may be include in the set of direct messages 255. Selecting a username 240 from the set of direct messages 255 may cause the user interface 230 to display a set of direct messages between the logged in user and the selected user in the central pane (e.g., direct messages that are stored in the system and displayed in a sequential order).

The central pane of the user interface 230 may display the contents of a selected channel. For example, if the user selects a channel with a channel ID 250-a, the central pane may display the selected channel ID 250-a, as well as data corresponding to this selected channel ID 250-a. The data for the channel may include a sequential listing of messages 270 posted to the channel. For example, a user with a username 240-e may post a first message 270-a at a first time corresponding to a timestamp 265-a. The user interface 230 may display, for the channel, this information, as well as affordances supporting actions associated with this information. For example, a user may react to the message 270-a, reply to the message 270-a, or both. As illustrated, another user with a username 240-f may post a second message 270-b at a time corresponding to a timestamp 265-b, and one or more users may reply to the message 270-b. The user interface 230 may indicate a set of replies 275 and one or more timestamps 265-c associated with the replies 275 (e.g., a timestamp 265-c corresponding to a most recent reply) with the message 270-b. Selecting the set of replies 275 may cause the user interface 230 to display the replies in a second sidebar (e.g., as a thread of messages).

The messages 270 may include text or other objects, such as files, photos, audio files, video files, documents, uniform resource locator (URL) links, or any other objects. If the selected channel is private, member of the channel may view the information related to the channel, while nonmembers of the channel may be blocked from viewing the information. If the selected channel is public, members and nonmembers of the channel may view the relevant information. In some cases, channels, users, workspaces 235, accounts, or some combination thereof may include accessibility settings or rules with may define viewing capabilities, editing capabilities, or both.

The user interface 230 may further support search functionality using a search bar 260. Additionally or alternatively, the user interface 230 may indicate a profile picture 280 of the currently logged in user, as well as a connection status 285 (e.g., online, offline, busy) of the user.

In some cases, the search functionality may search for text input into the search bar 260 within messages 270 across multiple channels. However, such searching may be inefficient, as the messages 270 in channels can be noisy and may fail to capture the high-level purpose of a channel. Additionally, multiple users may post to a channel and perform actions within a channel. A user accessing the channel may fail to identify all activities performed within the channel, which may lead to the user missing important information or actions.

To support efficient searching and automated tracking of activities within a channel, the group-based communication platform 205 may generate a canvas corresponding to a channel. The canvas may provide high-level information relating to the channel and may automatically track activities performed in the channel. In some cases, at channel creation, the group-based communication platform 205 may automatically trigger creation of the corresponding canvas and may populate one or more aspects of the canvas (e.g., populate one or more information blocks within the canvas). The canvas may provide additional functionality and an improved user experience for users of a channel, as described in more detail herein.

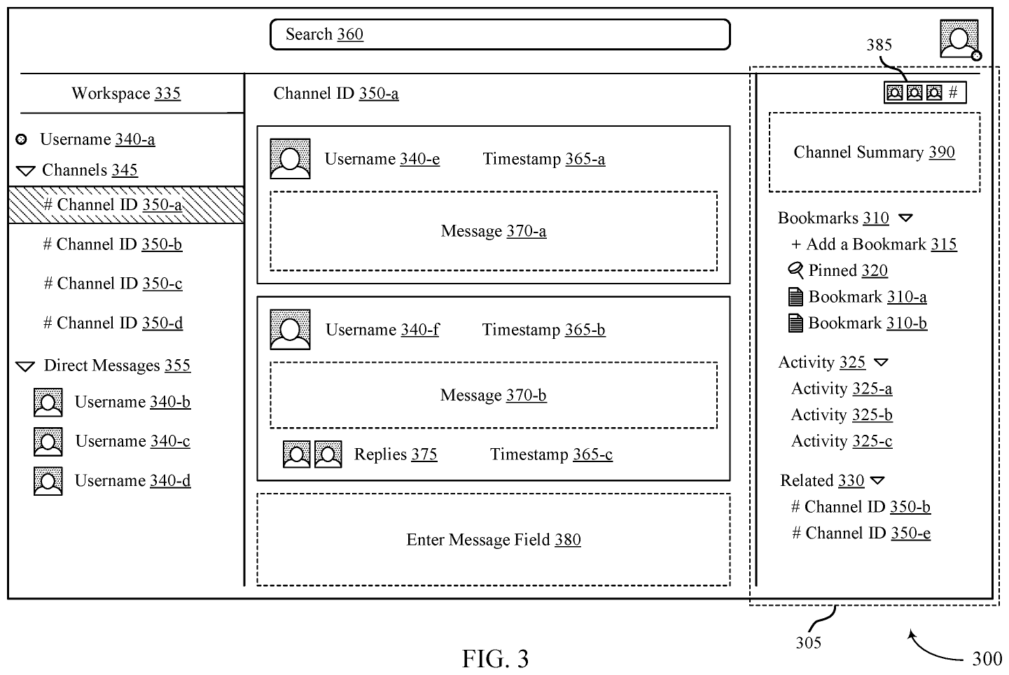

FIG. 3 illustrates an example of a user interface 300 that supports automatic canvas creation associated with a group-based communication channel in accordance with aspects of the present disclosure. The user interface 300 may be implemented by a user device, such as a user device described with reference to FIGS. 1 and 2. The user interface 300 may include a canvas 305 corresponding to a specific channel in a group-based communication system. For example, a group-based communication platform may support multiple group-based communication channels, and the user interface 300 may display information relating to a group-based communication channel corresponding to a channel ID 350-a. The channel may further be associated with the canvas 305, which in some cases may be referred to as a channel about page. The canvas 305 may provide information or other context about the corresponding channel (e.g., the channel with channel ID 350-a). In some cases, as illustrated, the user interface 300 may concurrently display the canvas 305 with a sequential listing of messages 370 for the channel. For example, the user interface 300 may include a first sidebar including navigation information for a user, a central pane including the channel contents (e.g., the sequential listing of messages 370 corresponding to the channel ID 350-a), and a second sidebar including the canvas 305. Alternatively, the canvas 305 may be displayed in the central pane. For example, a user may select an affordance (e.g., a button) to expand the canvas 305 from a sidebar to the central pane. In some examples, the canvas 305 may be displayed as a floating card in the user interface 300.

The user device including the user interface 300 may communicate with the group-based communication platform (e.g., over a network, using a downloaded application). For example, the user device may receive, from the group-based communication platform, data to display in the user interface 300. The user device may further send, to the group-based communication platform, user inputs received via the user interface 300. For example, a user operating the user device may interact with features of the user interface 300 to view specific channels, post messages 370, send direct messages 355 to other users, perform searches, modify the canvas 305, or any combination of these or other actions supported by the user interface 300.

A user may log into the group-based communication system using a username 340-a and may view a channel corresponding to a channel ID 350-a. For example, the navigation pane in the first sidebar may indicate a workspace 335 for the user, a set of channels 345 for the user, including a channel ID 350-a, a channel ID 350-b, a channel ID 350-c, and a channel ID 350-d, and set of direct messages 355 corresponding to a username 340-b, a username 340-c, and a username 340-d. The user interface 300 may display the contents of the selected channel (e.g., with channel ID 350-a) in the central pane. For example, the selected channel may include a message 370-a posted by a user with a username 340-e at a timestamp 365-a and a message 370-b posted by a user with a username 340-f at a timestamp 365-b. The second message 370-b may be associated with a set of replies 375 with a most recent timestamp 365-c. The central pane may further include an affordance 380 for posting messages to the channel. The affordance 380 may include one or more features for posting messages, which may support typing a message, adding a link, attaching a file (e.g., a photo, a document, a video, an audio recording), copying a user, or the like.

The user interface 300 may further display the canvas 305 corresponding to the selected channel (e.g., corresponding to the channel ID 350-a). The canvas 305 may include one or more information blocks associated with the channel. Some information blocks may be auto-generated for the canvas 305. For example, upon creation of the channel with the channel ID 350-a, the group-based communication system may additionally create the corresponding canvas 305 with one or more auto-generated information blocks. Additionally or alternatively, a user may add, remove, or modify information blocks in the canvas 305. In some cases, the canvas 305 may be directly editable by any users of the channel (e.g., members of the channel or users with editing permissions for the channel). In some other cases, select users (e.g., administrative users, the channel creator) may be able to edit the canvas 305, while other users may view the canvas but may be restricted from editing the canvas 305.

The canvas 305 may include a channel summary 390, which may be a text field editable by one or more users of the channel. In some cases, the channel summary 390 may include a short description defining the purpose of the channel (e.g., the group-based communication channel corresponding to the channel ID 350-a). For example, the channel summary 390 may state “Organizing our teams for the 2021 rebrand. Please share key updates here.” The channel summary 390 may include other objects in addition or alternative to text, such as photos or links to documents, external websites, or the like. Upon creation of the channel, the user creating the channel may initially provide the channel summary 390. For example, the group-based communication platform may receive, from a user via the user interface 300, a request to create a channel. In response to the request, the group-based communication platform may generate the channel (e.g., information for the channel, including the channel ID 350-a, one or more settings for channel, or the like). Additionally, the group-based communication platform may generate the canvas 305 corresponding to the channel. For example, the channel may include a sequential listing of messages 370—or, upon creation, resources for storing a sequential listing of messages 370—and the canvas 305 associated with the channel. In some examples, further in response to the request to create the channel, the user interface 300 may display a request for the channel summary 390. That is, the user may be prompted to provide a channel summary 390 describe the channel at a high-level during creation of the channel. This initial channel summary 390 may support modifications by one or more users after creation.

In some examples, the canvas 305 may include an indication of the channel members 385. For example, at channel creation, the user requesting creation of the channel may indicate a set of users to invite to the channel as members. Additionally or alternatively, users may request membership to the channel.

Additionally or alternatively, the canvas 305 may include bookmarks 310. For example, the bookmarks 310 may support a user saving or otherwise highlighting specific information relating to a channel, like links to dashboards, mockups, documents, files, messages, or any other information. The bookmarks 310 may link to the indicated information, such that if a user selects a bookmark 310, the user's view in the user interface 300 may be redirected to view the information corresponding to the bookmark 310 in the central pane. In some examples, bookmarks 310 may link to other messages 370 or collaborative documents that reside in other channels of the group-based communication system. In some examples, the bookmarks 310 include messages 370 or files that have been pinned to the current channel. Bookmarks 310 may improve the functionality of the channel and the user experience, especially for channels with a significant number of members (e.g., over ten members) in which members can leverage the bookmarks 310 to stay up-to-date on the most important information in the channel. The canvas 305 may include an affordance to add a bookmark 315. For example, a first bookmark 310-a and a second bookmark 310-b may be added to the set of bookmarks 310 in the canvas. Additionally or alternatively, the canvas 305 may include a set of pinned objects 320, such as messages 370, files, documents, photos, recordings, or the like. The set of pinned objects 320 may be grouped together for display, and a user may select the set of pinned objects 320 in order to view a list of the individual pinned objects. The list of the individual pinned objects may also support links to the pinned objects, similar to the bookmarks 310. Accordingly, the bookmarks 310, the set of pinned objects 320, or both in the canvas 305 may support more efficient (e.g., lower latency) access to specific information in the channel, which may be especially helpful for channels with a significant quantity of messages 370 (e.g., tens or hundreds of messages 370 posted to the channel). In some cases, the canvas 305 (e.g., the channel about page) may serve as a replacement for a bookmark bar (e.g., while supporting additional functionality associated with the other information blocks in the canvas 305), or a bookmark bar in the user interface 300 and corresponding to the channel may act as a minimized version of the canvas 305 (e.g., if a user closes the canvas 305, the canvas 305 may be minimized to the bookmark bar).

In some examples, the canvas 305 may indicate a set of activities 325 associated with the channel. For example, the group-based communication platform may track a set of activities 325 performed within the channel that are related to a particular event or file, and the canvas 305 may display this tracked information to one or more users. Activities 325 may include object creation (e.g., channel creation, document creation), message posting, commenting on a message 370, reacting to a message 370, object editing, object sharing, adding a member, removing a member, changing a channel setting, or any other actions performed by a user in the channel. For example, the set of activities 325 may track both actions related to the sequence of messages 370 (e.g., posting a message 370, deleting a message 370, replying to a message 370) and actions related to the canvas 305 (e.g., editing information presented in the canvas 305, adding a new information block to the canvas 305, removing an information block from the canvas 305). The group-based communication platform may automatically track (e.g., store information relating to) the actions performed in the channel and may update the displayed set of activities 325 in realtime, pseudo-realtime, or upon a refresh of the user interface 300. In some cases, the information capturing the aspects of the activities may be stored in a database or cloud-resources associated with the group-based communication system. In some examples, it may be too noisy to track every action taken in the channel, so the channel or canvas 305 may track a subset of key activities (e.g., rather than all activities). In some examples, a subset of activities 325 in the channel relating to assigned tasks, workflows, and calendar events may be tracked and updated in the canvas 305.

The set of activities 325 displayed in the canvas 305 may include a subset of the total activities performed in the channel. For example, the subset may include a threshold quantity of most-recent activities (e.g., the five most recent activities in the channel), the activities performed within a threshold time (e.g., activities performed within the past 24 hours), or some other subset of the activities. Additionally or alternatively, multiple activities may be grouped together for the display. For example, the user interface 300 may group multiple comments together as a single activity 325-a for display (e.g., “Lee+3 commented on Q2 Budget”). In some examples, an activity 325 may include one or more links. For example, the activity 325-a may include a link to the user “Lee,” the document “Q2 Budget,” one or more of the comments, or any combination thereof. A link to a user may be an example of an affordance that—if actuated (e.g., clicked)—redirects the user interface 300 to display a direct message with the corresponding user, the posts (e.g., messages 370, replies, documents) corresponding to the user, or both in the central pane. A link to a file (e.g., document, photo, spreadsheet, presentation, audio recording, video recording) may be an example of an affordance that—if actuated (e.g., clicked)—redirects the user interface 300 to display the file in the central pane. Accordingly, the set of activities 325 may improve the user experience by providing low latency access to specific information. Additionally, the set of activities 325 may ensure a user does not miss recent actions performed in a channel, by displaying these recent actions in an easily interpreted format.

As a specific example, the set of activities 325 may include indications of a first activity 325-a, a second activity 325-b, and a third activity 325-c (e.g., although any quantity of activities 325 may be stored, displayed, or both). The first activity 325-a may indicate “Lee +3 commented on Q2 Budget.” The second activity 325-b may indicate “Matt shared Q2 email copy.” The third activity 325-c may indicate “Natalie joined the channel.”

In some examples, the canvas 305 may indicate a set of related channels 330. The related channels 330 may be other channels associated with the channel with channel ID 350-a. In some cases, one or more users may define the related channels 330 (e.g., upon channel creation or later). The list of related channels 330 may include links to the one or more related channels 330 (e.g., a channel ID 350-b and a channel ID 350-e). These channel IDs 350 may be the same or different from channel IDs 350 presented in the navigation pane (e.g., in the set of channels 345 for the user). A link to a channel in the list of related channels 330 may be an example of an affordance that—if actuated (e.g., clicked)—redirects the user interface 300 to display the channel corresponding to the selected channel ID 350 in the central pane. In some cases, the list of related channels 330 may include indications of whether a related channel is a public channel, a private channel, a private channel to which the user is a member, a private channel to which the user is not a member, or any combination thereof. That is, the list of related channels 330 may indicate to the user whether the user can access the respective channel information via the link to the channel.

The channel summary 390, the bookmarks 310, the activities 325, and the list of related channels 330 may be examples of respective information blocks (e.g., content blocks) in the canvas 305. These information blocks may be auto-generated upon canvas 305 creation, may be added by a user, or a combination thereof. Additionally or alternatively, information blocks—auto-generated blocks or added blocks—may be removed from the canvas 305 by a user. The canvas 305 may support additional or alternative information blocks supporting additional or alternative functionality within the canvas 305. In this way, each canvas 305 corresponding to a respective channel may be configurable to the respective channel's specific needs or use cases.

In some examples, the canvas 305 may improve search functionality. For example, a user may input a query into the search bar 360. In response to the query, the user interface 300 may display an option to search the canvases 305 of channels or all information for the channels. By selecting to search the canvases 305, a user may significantly reduce the processing resources and latency involved in the search process, while supporting searching of information that provides high-level summaries of channels. Additionally or alternatively, the search functionality may weight results from a canvas 305 relatively more than results from a message 370 in a channel. Accordingly, the canvas 305 may improve search results while also reducing the resources involved in performing the searches. That is, the channel summary 390 of the canvas 305 may enable improved searching for channels and may provide users with a better idea of what the channel is about, for example, without a user having to join the channel.

In some cases, the canvas 305 (e.g., the channel about page for the channel ID 350-a) may be opened or closed in the display. For example, the user may select to open the canvas 305 in the sidebar or in the central pane. Alternatively, the user may select to close (e.g., minimize) the canvas 305. In some examples, the navigation pane (e.g., the first sidebar) may support reopening the canvas 305. For example, the set of channels 345 may additionally display channel about pages. In some cases, the channels (e.g., the channel IDs 350) and the channel about pages may be displayed as mixed top-level objects in the navigation pane (e.g., objects that support selection for display in the user interface 300). In some other cases, the channel objects may include the respective channel about page objects (e.g., in a hierarchical structure in the navigation pane), channel ID objects may include both channel objects and channel about page objects, any object may be a parent or child object within the hierarchical structure (e.g., a channel object may be a parent, a child, or both, and a channel about page object may similarly be a parent, a child, or both), or any combination thereof. Such structures may support nesting of objects within the first sidebar, such that a user may easily navigate to a specific channel, a specific channel about page (e.g., canvas 305), or both.

The canvas 305 (e.g., channel about page) may provide a user improved visibility into the corresponding channel and may augment the user's ability to provide information and context about the channel (or about information in the channel, such as a message, video, audio, user mention, or other information). As such, the canvas 305 may provide additional functionality (e.g., activity tracking) and improve the searching functionality, the navigation functionality, and the user experience associated with a group-based communication channel in a group-based communication system.

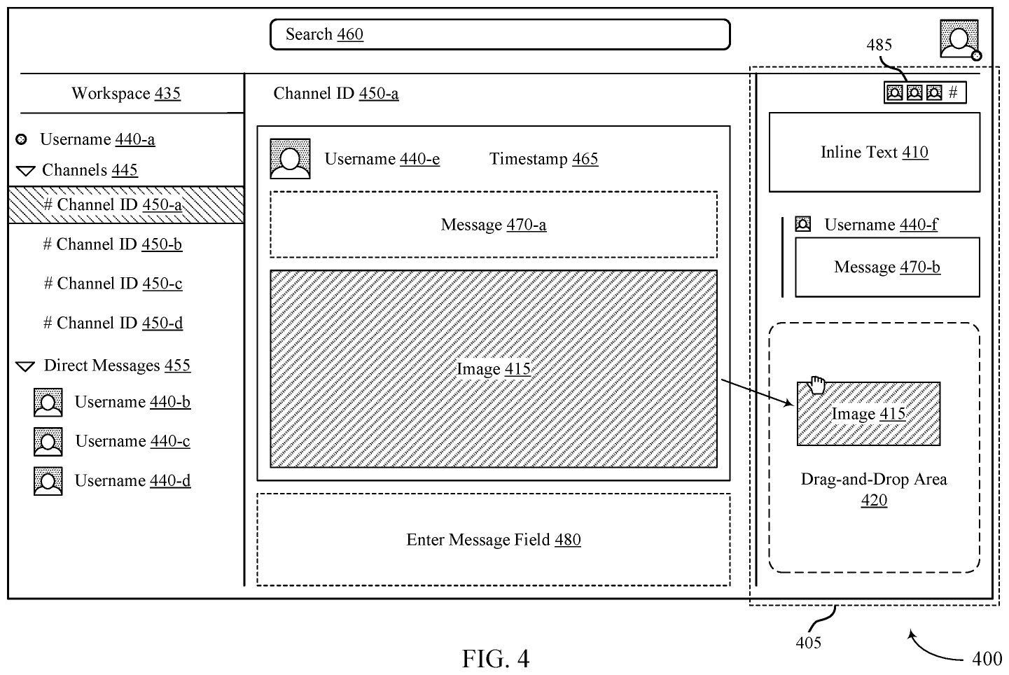

FIG. 4 illustrates an example of a user interface 400 that supports automatic canvas creation associated with a group-based communication channel in accordance with aspects of the present disclosure. The user interface 400 may be implemented by a user device, such as a user device described with reference to FIGS. 1 and 2. The user interface 400 may be an example of a user interface 230, a user interface 300, or both. For example, similar to the user interface 300 described herein with reference to FIG. 3, the user interface 400 may display a canvas 405 corresponding to a channel (e.g., with a channel ID 450-a). The user interface 400 may further display an indication of a workspace 435, a username 440-a of a logged in user, a set of channels 445 (e.g., including a channel ID 450-a, a channel ID 450-b, a channel ID 450-c, a channel ID 450-d, or any combination of these or other channel IDs 450), a set of direct messages 455 (e.g., corresponding to a username 440-b, a username 440-c, a username 440-d, or any combination of these or other usernames 440), or any combination of this information in a first sidebar. The user interface 400 may display, in a central pane, the currently viewed channel ID 450-a, a sequential set of messages (e.g., including a message 470-a posted by a user with a username 440-e at a timestamp 465 and including an image 415) and an affordance 480 for posting messages to the channel. Although the message 470-a is displayed as including an image 415, each message 470 may include text, images, files, URL links, documents, audio recordings, video recordings, or any other information posted by a user. The user interface 400 may support search functionality via a search bar 460. The user interface 400 may support additional functionality within the canvas 405 to improve the usability of the group-based communication channel.

The canvas 405 (e.g., a channel about page) may include an indication of the channel members 485. Additionally or alternatively, the canvas 405 may include inline text 410. For example, a user may input text directly into the canvas 405 for display within the canvas 405. As such, this text is not included elsewhere in the channel. The channel summary 390, as described with reference to FIG. 3, may be an example of inline text 410.

The canvas 405 may additionally or alternatively include information inserted or copied over from the channel (e.g., from the sequential listing of messages 470 for the channel, which may be referred to as the “chat”). As an example, the canvas 405 may include a drag-and-drop area 420 in which a user may drag and drop information from the channel (e.g., from the central pane). As illustrated, the user may drag an image 415 into the drag-and-drop area 420 to add the image 415 to the canvas 405 as—or within—an information block. If the image 415 is added to the canvas 405, the image 415 may be displayed within the canvas 405 (e.g., with or without a link to the corresponding image 415 in the channel). As an example, a message 470-b may have previously been added to the canvas 405, for example, using the drag-and-drop method. The canvas 405 may display the message 470-b in the sidebar, along with a username 440-f of the user who posted the message 470-b, a timestamp corresponding to the message 470-b, replies to the message 470-b, reactions to the message 470-b, or any combination thereof. Accordingly, the canvas 405 may support a second listing of messages different from the sequential listing of messages 470 in the channel. Because the canvas 405 may support arranging information blocks in any order or format, the listing of messages in the canvas 405 may be non-sequential and may allow the users of the channel to highlight or prioritize the display of specific messages 470, images 415, files, documents, recordings, or the like.

While a drag-and-drop method of adding data to the canvas 405 is described herein, other methods of adding data to the canvas 405 may be supported. For example, a message 470, an image 415, or any other object may include an affordance that, if actuated (e.g., selected), causes the display of an “Add to Channel About Page” option. If the “Add to Channel About Page” option is selected (e.g., the “Add to Channel About Page” affordance is actuated), the corresponding object may be added to the canvas 405. In some cases, the added object may be displayed in a last information block within the canvas 405. A user may rearrange the information blocks of the canvas 405 to position the added object anywhere within the canvas 405. Additionally or alternatively, the user interface 400 may display a preview of an object (e.g., an image 415 or another object) within the canvas 405.

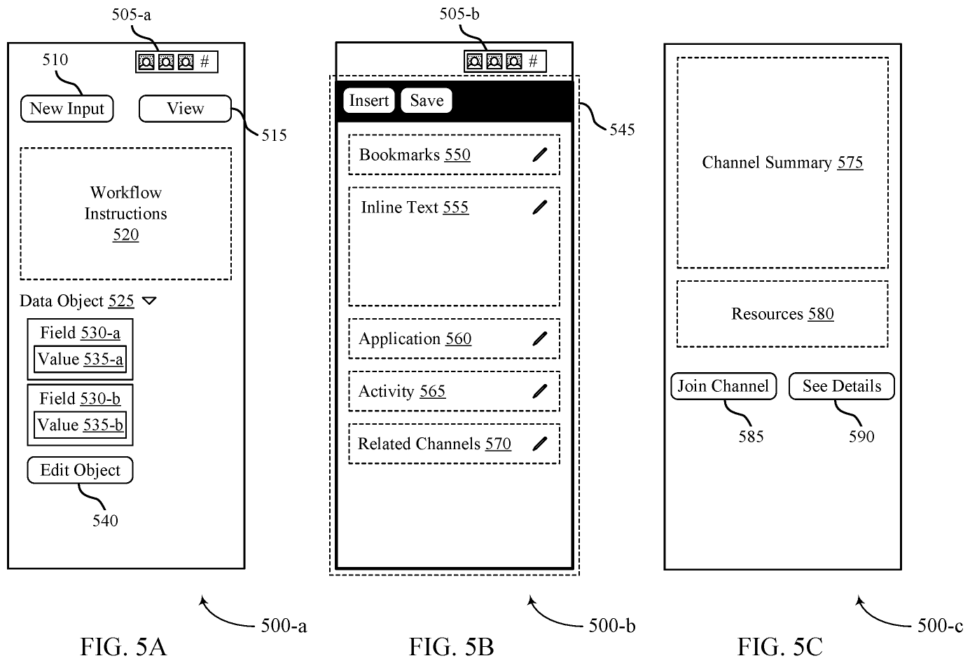

FIGS. 5A, 5B, and 5C illustrate examples of user interfaces 500 that support automatic canvas creation associated with a group-based communication channel in accordance with aspects of the present disclosure. The user interfaces 500 may be implemented by user devices, such as a user device described with reference to FIGS. 1 and 2. The user interfaces 500 may be examples of—or components of—user interfaces, such as a user interface 230, a user interface 300, a user interface 400, or any combination thereof. For example, the user interfaces 500 may display canvases (e.g., channel about pages) corresponding to respective channels, where the canvases may be examples of the canvas 305, the canvas 405, or both as described with reference to FIGS. 3 and 4. The user interfaces 500 may support additional functionality for channels within the canvases.

FIG. 5A illustrates an example of a user interface 500-a corresponding to a canvas associated with a channel. The user interface 500-a may support a workflow corresponding to the channel, data objects corresponding to the channel, or both. The canvas may include an indication of the channel members 505-a (e.g., an indication of the quantity of members of the channel, an indication of the profile pictures for one or more of the channel members).

In some examples, the canvas may support a workflow (e.g., a process flow). For example, the canvas may include affordances (e.g., button elements) supporting one or more aspects of a workflow. A workflow may be an example of a process flow including a sequenced set of operations to perform. The workflow may include operations performed within the group-based communication platform, operations performed within a database system (e.g., a multi-tenant database system), operations performed with external systems (e.g., email applications), or any combination thereof. As illustrated, the canvas may include a first affordance 510 supporting triggering execution of a workflow. For example, actuation of the first affordance 510 (e.g., selecting the “New Input” button element) may allow the user to trigger the workflow. If the workflow uses one or more input values, actuating the first affordance 510 may trigger the user interface 500-a to display one or more input fields, in which the user may provide user inputs to the workflow. The workflow may execute one or more operations based on the definition of the workflow, the user inputs, or both.

The canvas may further provide information relating to executing the workflow, such that a user may analyze the workflow or better understand the workflow. For example, the canvas may display a second affordance 515 supporting viewing previous workflow executions, previous inputs to the workflow, previous outputs of the workflow, or any combination thereof. Additionally or alternatively, the canvas may display workflow instructions 520, which may provide an explanation of the workflow (e.g., the inputs to the workflow, the outputs of the workflow, one or more operations within the workflow). The workflow instructions 520 may provide instructions for using the first affordance 510, the second affordance 515, or both. By supporting execution of workflows directly within the canvas, the canvas may improve the functionality of the group-based communication platform and may allow a user to process and analyze data effectively and efficiently, for example, while concurrently viewing the contents of the corresponding channel.

As a specific example, the group-based communication platform may support a workflow for submitting a ticket (e.g., a ticket relating to updating or fixing a device). The first affordance 510 may be for “New Tickets” and the second affordance 515 may be for “My Tickets” (e.g., referring to the currently logged in user's previously submitted tickets). The workflow instructions 520 may define how to use the channel (e.g., how to use the workflow in the channel.” The workflow instructions 520 may state “1. Use the ‘New Ticket’ button above; 2. Choose an appropriate category emoji for your ticket type: device request; device issue; or account clearance; 3. After submitting your ticket you will receive responses in a thread; If you need to recall past tickets you've submitted, use the ‘My Tickets’ button above’.”

Additionally or alternatively, in some examples, the canvas may support access to data objects within the canvas. For example, the group-based communication platform may be integrated with a third-party application, such as a CRM application. The group-based communication platform may provide secure access to data in the third-party application via the canvas. For example, the user device including the user interface 500-a may retrieve data corresponding to a data object 525 from a database system (e.g., a multi-tenant database system) and may display the data in the canvas. In some examples, the data object 525 may be retrieved and displayed based on the currently logged in user having permissions to access the data object 525. The canvas may display data relating to the data object 525, such as a value 535-a for a first data field 530-a of the data object 525 and a value 535-b for a second data field 530-b of the data object 525. The canvas may support retrieving and displaying any quantity or type of data associated with the data object 525. The canvas may provide an application programming interface (API) with which the user may select the data object(s), field(s), or both to display in the canvas, where the API supports communications between the group-based communication platform and a database system storing the data object(s). The values 535 displayed for the data object 525 may automatically update (e.g., in realtime, in pseudo-realtime, periodically, based on a refresh operation) if the corresponding values in the underlying database system are changed, for example, using a polling process, a detection of an edit to the data object 525, or both. By displaying the data object 525, the canvas may provide access to data from a third-party application, a database system, or both relating to the corresponding channel without navigating away from the corresponding channel.

In some cases, the canvas may support editing the data object directly in the canvas. For example, the canvas may display an affordance 540 supporting editing the data object 525. Additionally or alternatively, the user may edit a data field 530 of the data object 525 by modifying a corresponding value 535 with a user input. Editing the data field 530 in the canvas may trigger sending a request to the underlying third-party application, database system, or both to modify the stored data object. In some examples, the canvas may request credentials from a user (e.g., for a database system) in order to trigger sending a modification request to the database system in response to user inputs to the canvas. In this way, the canvas may provide richer experiences (e.g., as compared to inline text) corresponding to platform applications, data, tasks, or other procedures relating to a channel.

FIG. 5B illustrates an example of a user interface 500-b corresponding to a canvas associated with a channel. The user interface 500-b may support editing and saving changes to the canvas. The canvas may include an indication of the channel members 505-b.

A user may select to edit the canvas (e.g., the display format for the canvas). In some cases, the canvas may include multiple display formats (e.g., a display format for the canvas displayed in a sidebar, a display format for the canvas displayed in a central pane) that may be jointly or separately edited. The canvas may include a first affordance that—if actuated—triggers an editing window 545 for the canvas. The editing window 545 may include one or more affordances, for example, for inserting a new information block into the canvas, for deleting an information block from the canvas, for modifying an existing information block in the canvas, for saving changes to the canvas, or any combination thereof.

As illustrated, the user may edit information blocks for bookmarks 550, inline text 555, applications 560, activities 565, related channels 570, or any combination of these or other information blocks supported by the canvas. The canvas may support document-like editing, where a user may type user inputs into the information blocks of the canvas to change information in the information blocks. In some examples, the canvas may support re-ordering of information blocks (e.g., using a drag-and-drop method or another method) to allow for user-based customization of the display format for the canvas. Additionally or alternatively, the user may edit one or more settings associated with the canvas (e.g., editing permissions, access permissions, a template of the canvas, a theme for the canvas).

The canvas may support concurrent editing by multiple users. For example, two users viewing the channel and the corresponding canvas on different user devices may select to edit the canvas concurrently. In some cases, edits being made by a first user may be displayed to a second user (e.g., as tracked changes associated with the first user's username). The first user selecting to save changes to the channel may save the first user's changes and may refrain from saving changes made concurrently by other users. Alternatively, the first user may select to save all changes to the canvas, including changes made concurrently by other users.

FIG. 5C illustrates an example of a user interface 500-c corresponding to a canvas associated with a channel. The user interface 500-c may support a view of a canvas for a non-member user of the channel. For example, if the channel is private or otherwise non-viewable to one or more users, the canvas may still display information to a user without access to the channel. This information may allow the user to search for the channel and provide the user with a high-level description of the channel. However, the canvas may obfuscate (or otherwise hide or refrain from rendering) sensitive information or any information not approved for viewing by users without access to the channel.

For example, the canvas may include a first display format for users without access to the channel and a second display format for users with access to the channel. The first display format may include a subset of the information included in the second display format. As an example, the first display format of the canvas may display a channel summary 575, one or more resources 580, an affordance 585 (e.g., a button element) to join the channel, an affordance 590 (e.g., a button element) to see more details relating to the channel, or any combination thereof. The channel summary 575 may support searching for the channel even by a user who does not have access to view the contents of the channel. This may allow the user to learn about the channel's existence and request access to the channel. Alternatively, some channels may hide their corresponding canvases from non-members, such that non-members may not find the channel via searches. Non-members of such channels may learn about the channels by being invited to join by an existing member, not by using the corresponding canvases. In some cases, if a non-member selects the affordance 585 to join the channel, the non-member may automatically be added as a member of the channel. In some other cases, if the non-member selects the affordance 585 to join the channel, the canvas may trigger sending a membership request to one or more current members of the channel (e.g., a user with membership controls for the channel) and may or may not add the non-member as a member of the channel based on whether the membership request is approved or denied by a current member of the channel.

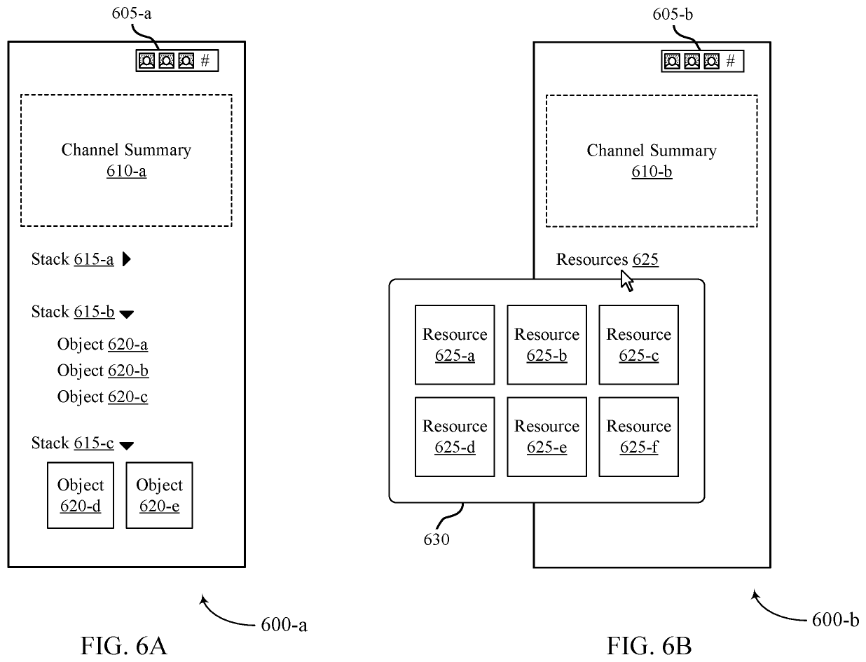

FIGS. 6A and 6B illustrate examples of user interfaces 600 that support automatic canvas creation associated with a group-based communication channel in accordance with aspects of the present disclosure. The user interfaces 600 may be implemented by user devices, such as a user device described with reference to FIGS. 1 and 2. The user interfaces 600 may be examples of—or components of—user interfaces, such as a user interface 230, a user interface 300, a user interface 400, a user interface 500, or any combination thereof. For example, the user interfaces 600 may display canvases (e.g., channel about pages) corresponding to respective channels, where the canvases may be examples of the canvas 305, the canvas 405, or both as described with reference to FIGS. 3 and 4. The user interfaces 600 may support additional functionality for channels within the canvases.

FIG. 6A illustrates an example of a user interface 600-a corresponding to a canvas associated with a channel. The user interface 600-a may use stacks 615 with expandable headers as containers of objects 620 (e.g., mixed objects). The stacks 615 may support a dynamic view of information in the canvas, such that a user may expand a stack 615 to view one or more objects 620 within the stack 615 or may close the stack 615 to reduce the clutter in the canvas and provide a more streamlined view of the information in the canvas.

As an example, the canvas may include an indication of the channel members 605-a, a channel summary 610-a, or both. Additionally, the canvas may include any quantity of stacks 615 containing any quantity of nested objects 620 within the stacks 615. In some cases, the display format for the objects 620 within a stack 615 may be defined by a user. The objects 620 within a stack 615 may include data objects from a database system, text, files, documents, images, resources, recordings, URL links, or any combination of these or other objects 620 relating to a channel. As illustrated, a first stack 615-a may be unexpanded. A second stack 615-b may be expanded to grant access to a first object 620-a, a second object 620-b, and a third object 620-c. A third stack 615-c may be expanded to grant access to a first object 620-d and a second object 620-e. The stacks 615 may include affordances (e.g., toggles) supporting expanding and closing the stack 615. Selecting the affordance of a stack 615 may trigger the group-based communication platform to render or refrain from rendering the objects 620 corresponding to the stack 615.

FIG. 6B illustrates an example of a user interface 600-b corresponding to a canvas associated with a channel. The user interface 600-b may provide an alternate view for expanding a stack, as described with reference to FIG. 6A. For example, rather than expanding a stack within a sidebar, the user interface 600-b may support expanding a stack as a flyout 630 from a folder. For example, the resources 625 may be an example of a stack. The resources 625 may be displayed as a folder or selectable text when closed. If a user selects the resources 625, the resources 625 may expand to display the individual resources within the resources 625 (e.g., objects within the stack). As an example, a user may actuate an affordance (e.g., select a button element) corresponding to the resources 625. In response, the group-based communication platform may cause the user device to render, in the user interface 600-b, a flyout 630 displaying a resource 625-a, a resource 625-b, a resource 625-c, a resource 625-d, a resource 625-e, and a resource 625-f corresponding to the resources 625 (although any quantity of resources 625 may be supported). In some cases, the canvas may further include an indication of the channel members 605-b, a channel summary 610-b, or both.

In some examples, a user interface may support dragging and dropping a stack (e.g., as described with respect to FIG. 6A or FIG. 6B) from the canvas (e.g., the sidebar) into the channel (e.g., the sequential listing of messages in the central pane) or vice versa. Additionally or alternatively, stacks may be shared between channels, users (e.g., via direct messages), or both.

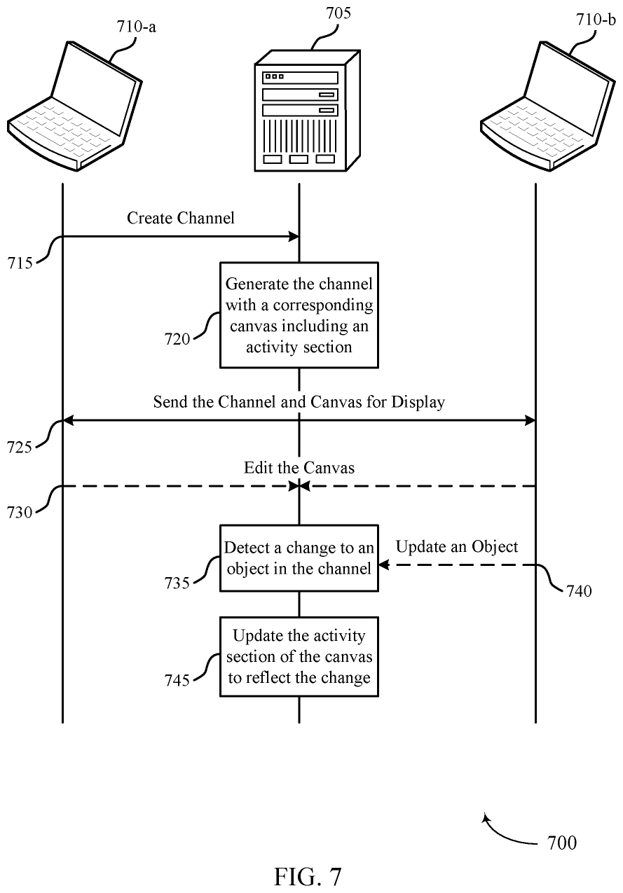

FIG. 7 illustrates an example of a process flow 700 that supports automatic canvas creation associated with a group-based communication channel in accordance with aspects of the present disclosure. The process flow 700 may be implemented by a group-based communication system including one or more computing devices 705 and one or more user devices 710. The computing device 705 may host a group-based communication platform. The user device 710-a and the user device 710-b may access the group-based communication platform over a network, based on downloading an application, or both. The user device 710-a and the user device 710-b may include user interfaces that can display information corresponding to the group-based communication platform, as described herein with reference to FIGS. 1 through 6B. Alternative examples of the following may be implemented, where some processes are performed in a different order than described or are not performed at all. In some examples, processes may include additional features not mentioned below, or further processes may be added.

At 715, a user may create a channel in the group-based communication platform. For example, a first user operating the user device 710-a may provide a user input requesting channel generation (e.g., by actuating an affordance). The computing device 705 may receive the request to create the group-based communication channel in the group-based communication platform.

At 720, the computing device 705 may generate the group-based communication channel in response to the request. Additionally, the computing device 705 may generate a corresponding canvas associated with the channel. The canvas may provide additional information and features relating to the associated channel. For example, the canvas may include multiple information blocks, and one or more of the information blocks may display information corresponding to objects (e.g., messages, files, users) in the channel. The canvas may be auto-generated along with the channel, and one or more of the information blocks in the canvas may similarly by auto-generated along with the channel (e.g., based on aspects or settings of the channel). At least one information block may display a set of activities (e.g., actions) performed in the channel. Additionally or alternatively, the canvas may include (e.g., in one or more information blocks) text, an object (e.g., a file, an image, an audio recording, a video recording, a document), a preview of an object, a bookmarks section, a related channels section, or any combination thereof.

At 725, the computing device 705 may send the channel and the canvas for display in a user interface of a user device 710. For example, the computing device 705 may send the channel and canvas for display at the user device 710-a, the user device 710-b, or both. In some examples, the canvas and channel contents (e.g., a sequential listing of messages for the channel) may be displayed concurrently in a user interface of a user device 710.

Additionally, the canvas may be directly editable by multiple users accessing the channel. For example, both the user device 710-a and the user device 710-b may have access to the channel and may view the canvas (e.g., in a sidebar concurrent to viewing the channel contents in a central pane of the user interface). At 730, multiple users (e.g., the user operating the user device 710-a and the user operating the user device 710-b) may edit the canvas (e.g., modify an information block, remove an information block, add an information block).

If the canvas corresponding to the channel includes an information block tracking channel activities, the computing device 705 may monitor for activities performed in the channel and may automatically update the information block to indicate any detected activities performed in the channel. For example, at 735, the computing device 705 may detect a change to an object in the channel. In some cases, the change may be based on a user input at 740 updating an object in the channel, such as posting a message, reacting or responding to a message, sharing a file, adding a new channel member, executing a workflow, modifying a data object, modifying the canvas, or any combination of these or other activities. At 745, in response to detecting the change to the object, the computing device 705 may update the information block (e.g., an activities section) configured to track the channel activities in order to reflect the detected change to the object. The computing device 705 may update the canvas displayed in one or more user interfaces to include the updated information block.

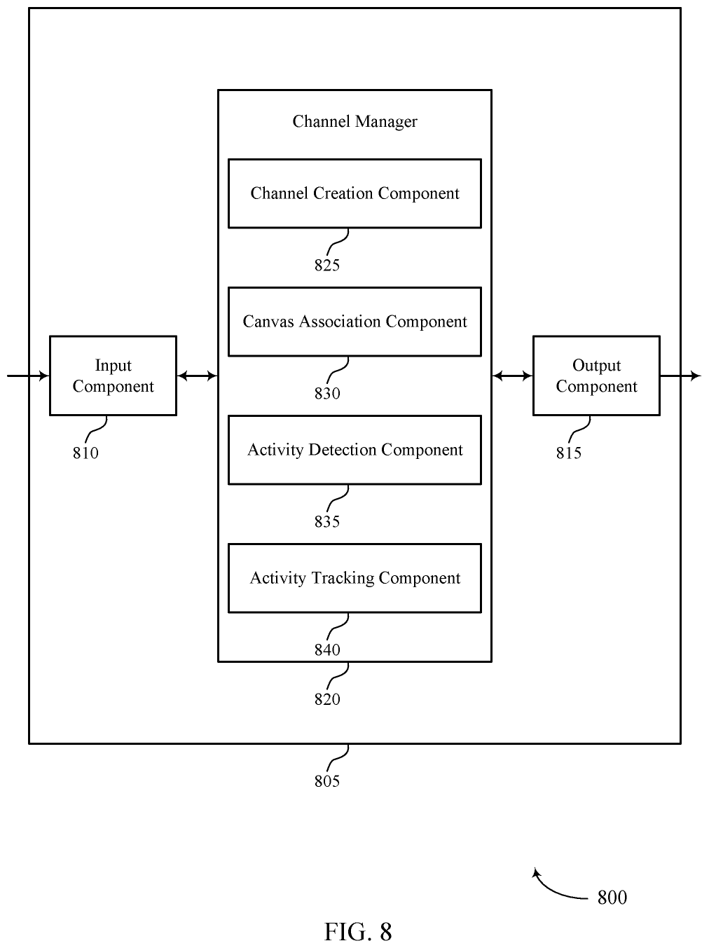

FIG. 8 shows a block diagram 800 of a device 805 that supports automatic canvas creation associated with a group-based communication channel in accordance with aspects of the present disclosure. The device 805 may include an input component 810, an output component 815, and a channel manager 820. The device 805 may also include a processor. Each of these components may be in communication with one another (e.g., via one or more buses).

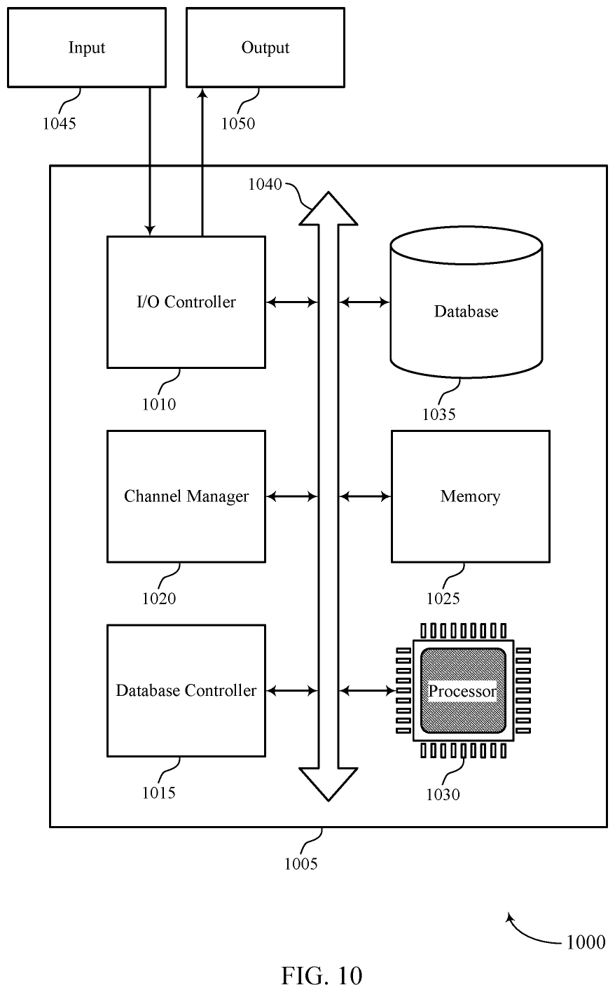

The input component 810 may manage input signals for the device 805. For example, the input component 810 may identify input signals based on an interaction with a modem, a keyboard, a mouse, a touchscreen, or a similar device. These input signals may be associated with user input or processing at other components or devices. In some cases, the input component 810 may utilize an operating system such as iOS®, ANDROID®, MS-DOS®, MS-WINDOWS®, OS/2®, UNIX®, LINUX®, or another known operating system to handle input signals. The input component 810 may send aspects of these input signals to other components of the device 805 for processing. For example, the input component 810 may transmit input signals to the channel manager 820 to support automatic canvas creation associated with a group-based communication channel. In some cases, the input component 810 may be a component of an input/output (I/O) controller 1010 as described with reference to FIG. 10.

The output component 815 may manage output signals for the device 805. For example, the output component 815 may receive signals from other components of the device 805, such as the channel manager 820, and may transmit these signals to other components or devices. In some examples, the output component 815 may transmit output signals for display in a user interface, for storage in a database or data store, for further processing at a server or server cluster, or for any other processes at any number of devices or systems. In some cases, the output component 815 may be a component of an I/O controller 1010 as described with reference to FIG. 10.

The channel manager 820 may include a channel creation component 825, a canvas association component 830, an activity detection component 835, an activity tracking component 840, or any combination thereof. In some examples, the channel manager 820, or various components thereof, may be configured to perform various operations (e.g., receiving, monitoring, transmitting) using or otherwise in cooperation with the input component 810, the output component 815, or both. For example, the channel manager 820 may receive information from the input component 810, send information to the output component 815, or be integrated in combination with the input component 810, the output component 815, or both to receive information, transmit information, or perform various other operations as described herein.

The channel manager 820 may support creating a channel-specific canvas in accordance with examples as disclosed herein. The channel creation component 825 may be configured as or otherwise support a means for receiving a request to create a channel in a group-based communication system. The canvas association component 830 may be configured as or otherwise support a means for, in response to the request, generating the channel in the group-based communication system, wherein the channel comprises a canvas associated with the channel and a plurality of objects comprising at least information associated with a sequential listing of messages for the channel. The channel may comprise a plurality of information blocks associated with the channel and auto-generated based at least in part on generating the channel. The plurality of information blocks may comprise at least an information block configured to track activity associated with the plurality of objects in the channel. The activity detection component 835 may be configured as or otherwise support a means for detecting a change to an object of the plurality of objects in the channel. The activity tracking component 840 may be configured as or otherwise support a means for, in response to detecting the change, updating the information block configured to track the activity associated with the plurality of objects to reflect the detected change to the object and causing display of the canvas associated with the channel to be updated based at least in part on the updated information block.

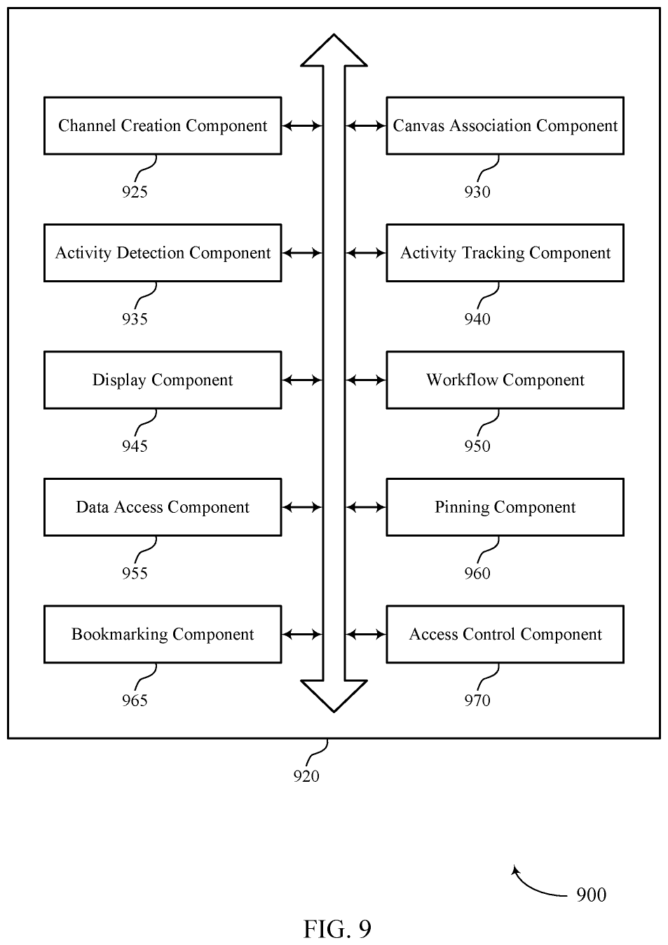

FIG. 9 shows a block diagram 900 of a channel manager 920 that supports automatic canvas creation associated with a group-based communication channel in accordance with aspects of the present disclosure. The channel manager 920 may be an example of aspects of a group-based communication system, a group-based communication platform, a channel manager 820, or any combination thereof as described herein. The channel manager 920, or various components thereof, may be an example of means for performing various aspects of automatic canvas creation associated with a group-based communication channel as described herein. For example, the channel manager 920 may include a channel creation component 925, a canvas association component 930, an activity detection component 935, an activity tracking component 940, a display component 945, a workflow component 950, a data access component 955, a pinning component 960, a bookmarking component 965, an access control component 970, or any combination thereof. Each of these components may communicate, directly or indirectly, with one another (e.g., via one or more buses).

The channel manager 920 may support creating a channel-specific canvas in accordance with examples as disclosed herein. The channel creation component 925 may be configured as or otherwise support a means for receiving a request to create a channel in a group-based communication system. The canvas association component 930 may be configured as or otherwise support a means for, in response to the request, generating the channel in the group-based communication system, wherein the channel comprises a canvas associated with the channel and a plurality of objects comprising at least information associated with a sequential listing of messages for the channel. The canvas may comprise a plurality of information blocks associated with the channel and auto-generated based at least in part on generating the channel. The plurality of information blocks may comprise at least an information block configured to track activity associated with the plurality of objects in the channel. The activity detection component 935 may be configured as or otherwise support a means for detecting a change to an object of the plurality of objects in the channel. The activity tracking component 940 may be configured as or otherwise support a means for, in response to detecting the change, updating the information block configured to track the activity associated with the plurality of objects to reflect the detected change to the object and causing display of the canvas associated with the channel to be updated based at least in part on the updated information block.

In some examples, the plurality of information blocks comprises text, an object, a file, an image, an audio recording, a video recording, a document, a bookmarks section, a related channels section, or any combination thereof.

In some examples, the canvas is directly editable by a plurality of users accessing the channel. In some examples, the plurality of users comprises members of the channel.

In some examples, the display component 945 may be configured as or otherwise support a means for sending, for concurrent display in a user interface of a user device, the canvas and the sequential listing of messages for the channel. In some examples, the canvas is displayed in a sidebar of the user interface and the sequential listing of messages for the channel is concurrently displayed in a central pane of the user interface.

In some examples, the canvas further comprises a preview of an object associated with the channel.

In some examples, the canvas further comprises at least a portion of a workflow associated with the channel, and the workflow comprises one or more processes to perform. The display component 945 may be configured as or otherwise support a means for sending, for display in a user interface of a user device, the canvas comprising one or more triggers associated with the workflow. The workflow component 950 may be configured as or otherwise support a means for receiving a user input from the user interface corresponding to at least one trigger of the one or more triggers associated with the workflow. The workflow component 950 may be configured as or otherwise support a means for, in response to receiving the user input, performing the one or more processes of the workflow based at least in part on the at least one trigger.

In some examples, the canvas further comprises a data object associated with the channel, and the data access component 955 may be configured as or otherwise support a means for accessing, from the canvas, the data object in a database system. The display component 945 may be configured as or otherwise support a means for sending, for display in a user interface of a user device, the canvas comprising data corresponding to the data object based at least in part on accessing the data object in the database system.

In some examples, the data access component 955 may be configured as or otherwise support a means for receiving a user input from the user interface modifying at least a portion of the data corresponding to the data object within the canvas. In some examples, the data access component 955 may be configured as or otherwise support a means for, in response to the user input, accessing the database system to modify one or more data objects in the database system to reflect at least the modified portion of the data.

In some examples, the database system comprises a multi-tenant database system. In some such examples, the data corresponding to the data object is associated with standard data objects for a plurality of tenants of the database system, custom data objects associated with a tenant of the plurality of tenants of the database system, or a combination thereof.

In some examples, the pinning component 960 may be configured as or otherwise support a means for receiving a user input pinning a message, a file, or both from the sequential listing of messages to the canvas. In some examples, the pinning component 960 may be configured as or otherwise support a means for, in response to receiving the user input, updating the canvas to comprise a pin corresponding to the message, the file, or both and causing display of the canvas associated with the channel to be updated based at least in part on the pin.

In some examples, the bookmarking component 965 may be configured as or otherwise support a means for receiving a user input bookmarking a message, a file, or both from the sequential listing of messages at the canvas. In some examples, the bookmarking component 965 may be configured as or otherwise support a means for, in response to receiving the user input, updating the canvas to comprise a bookmark linking to the message, the file, or both and causing display of the canvas associated with the channel to be updated based at least in part on the bookmark. In some examples, the bookmarking component 965 may be configured as or otherwise support a means for receiving an additional user input selecting the bookmark from the canvas. In some examples, the display component 945 may be configured as or otherwise support a means for, in response to receiving the additional user input, updating a display of the sequential listing of messages to display the message, the file, or both based at least in part on the bookmark linking to the message, the file, or both.

In some examples, the access control component 970 may be configured as or otherwise support a means for receiving an update to one or more first access parameters for the channel. In some examples, the access control component 970 may be configured as or otherwise support a means for, in response to receiving the update to the one or more first access parameters for the channel, updating one or more second access parameters for the canvas based at least in part on the updated one or more first access parameters.

In some examples, the display component 945 may be configured as or otherwise support a means for sending, for display in a user interface of a user device associated with a user, at least a portion of the canvas based at least in part on the user not being a member of the channel, wherein the portion of the canvas comprises a subset of information associated with the channel, the canvas, or both. In some examples, the subset of information comprises highlights of the channel based at least in part on a security parameter associated with the channel.

In some examples, the canvas further comprises one or more tasks, one or more actions, one or more assignable objects, or a combination thereof associated with the channel. In some examples, a display format of the canvas is organized according to one or more tabs, one or more folders, one or more bookmarks, or a combination thereof. In some examples, the canvas further comprises one or more stacks. In some examples, a stack of the one or more stacks is a container comprising data associated with one or more data types grouped together in the stack.

FIG. 10 shows a diagram of a system 1000 including a device 1005 that supports automatic canvas creation associated with a group-based communication channel in accordance with aspects of the present disclosure. The device 1005 may be an example of or include the components of a device 805 as described herein. For example, the device 1005 may be an example or component of a group-based communication system, a group-based communication platform, one or more computing devices, one or more databases, or any combination thereof. The device 1005 may include components for bi-directional data communications including components for transmitting and receiving communications, such as a channel manager 1020, an I/O controller 1010, a database controller 1015, a memory 1025, a processor 1030, and a database 1035. These components may be in electronic communication or otherwise coupled (e.g., operatively, communicatively, functionally, electronically, electrically) via one or more buses (e.g., a bus 1040).

The I/O controller 1010 may manage input signals 1045 and output signals 1050 for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. In other cases, the I/O controller 1010 may represent or interact with a modem, a keyboard, a mouse, a touchscreen, or a similar device. In some cases, the I/O controller 1010 may be implemented as part of a processor 1030. In some examples, a user may interact with the device 1005 via the I/O controller 1010 or via hardware components controlled by the I/O controller 1010.

The database controller 1015 may manage data storage and processing in a database 1035. In some cases, a user may interact with the database controller 1015. In other cases, the database controller 1015 may operate automatically without user interaction. The database 1035 may be an example of a single database, a distributed database, multiple distributed databases, a data store, a data lake, or an emergency backup database.

Memory 1025 may include random-access memory (RAM) and read-only memory (ROM). The memory 1025 may store computer-readable, computer-executable software including instructions that, when executed, cause the processor 1030 to perform various functions described herein. In some cases, the memory 1025 may contain, among other things, a basic I/O system (BIOS) which may control basic hardware or software operation such as the interaction with peripheral components or devices.

The processor 1030 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 1030 may be configured to operate a memory array using a memory controller. In other cases, a memory controller may be integrated into the processor 1030. The processor 1030 may be configured to execute computer-readable instructions stored in a memory 1025 to perform various functions (e.g., functions or tasks supporting automatic canvas creation associated with a group-based communication channel).

The channel manager 1020 may support creating a channel-specific canvas in accordance with examples as disclosed herein. For example, the channel manager 1020 may be configured as or otherwise support a means for receiving a request to create a channel in a group-based communication system. The channel manager 1020 may be configured as or otherwise support a means for in response to the request, generating the channel in the group-based communication system, wherein the channel comprises a canvas associated with the channel and a plurality of objects comprising at least information associated with a sequential listing of messages for the channel, the canvas comprising a plurality of information blocks associated with the channel and auto-generated based at least in part on generating the channel, wherein the plurality of information blocks comprises at least an information block configured to track activity associated with the plurality of objects in the channel. The channel manager 1020 may be configured as or otherwise support a means for detecting a change to an object of the plurality of objects in the channel. The channel manager 1020 may be configured as or otherwise support a means for in response to detecting the change, updating the information block configured to track the activity associated with the plurality of objects to reflect the detected change to the object and causing display of the canvas associated with the channel to be updated based at least in part on the updated information block.

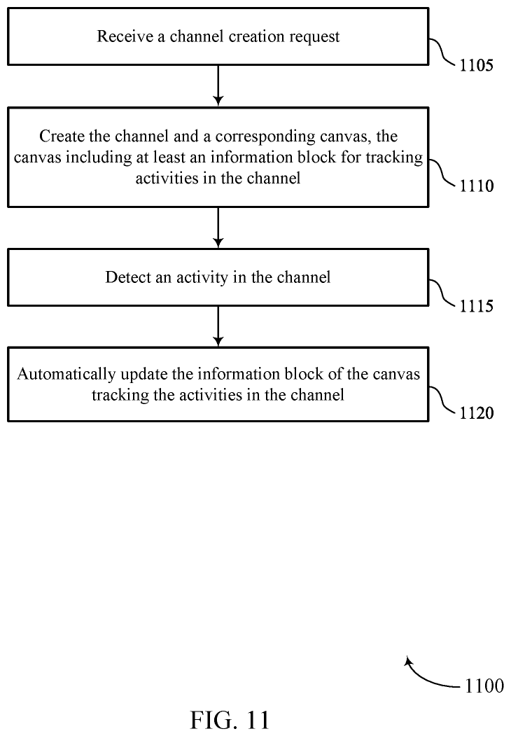

FIG. 11 shows a flowchart illustrating a method 1100 that supports automatic canvas creation associated with a group-based communication channel in accordance with aspects of the present disclosure. The operations of the method 1100 may be implemented by a group-based communication platform or its components (e.g., a computing device, such as an application server, a database server, a cloud-based server or service, a worker server, a server cluster, a virtual machine, a container, or any combination of these or other computing devices) as described herein. For example, the operations of the method 1100 may be performed by a group-based communication platform as described with reference to FIGS. 1 through 10. In some examples, a group-based communication platform may execute a set of instructions to control the functional elements of the group-based communication platform to perform the described functions. Additionally or alternatively, the group-based communication platform may perform aspects of the described functions using special-purpose hardware.

At 1105, the method may include receiving a channel creation request. For example, the method may involve receiving a request to create a channel in a group-based communication system. The operations of 1105 may be performed in accordance with examples as disclosed herein. In some examples, aspects of the operations of 1105 may be performed by a channel creation component 925 as described with reference to FIG. 9.

At 1110, the method may include creating the channel and a corresponding canvas, where the canvas includes at least an information block for tracking activities in the channel. For example, the method may involve—in response to the request—generating the channel in the group-based communication system, wherein the channel comprises a canvas associated with the channel and a plurality of objects comprising at least information associated with a sequential listing of messages for the channel, the canvas comprising a plurality of information blocks associated with the channel and auto-generated based at least in part on generating the channel, wherein the plurality of information blocks comprises at least an information block configured to track activity associated with the plurality of objects in the channel. The operations of 1110 may be performed in accordance with examples as disclosed herein. In some examples, aspects of the operations of 1110 may be performed by a canvas association component 930 as described with reference to FIG. 9.

At 1115, the method may include detecting an activity in the channel. For example, the method may involve detecting a change to an object of the plurality of objects in the channel. In some examples, the detected change may be to particular objects associated with the canvas such as a pinned document or a triggered workflow. The operations of 1115 may be performed in accordance with examples as disclosed herein. In some examples, aspects of the operations of 1115 may be performed by an activity detection component 935 as described with reference to FIG. 9.

At 1120, the method may include automatically updating the information block of the canvas tracking the activities in the channel. For example, the method may involve—in response to detecting the change—updating the information block configured to track the activity associated with the plurality of objects to reflect the detected change to the object. The method may further involve causing display of the canvas associated with the channel to be updated based at least in part on the updated information block. The operations of 1120 may be performed in accordance with examples as disclosed herein. In some examples, aspects of the operations of 1120 may be performed by an activity tracking component 940 as described with reference to FIG. 9.

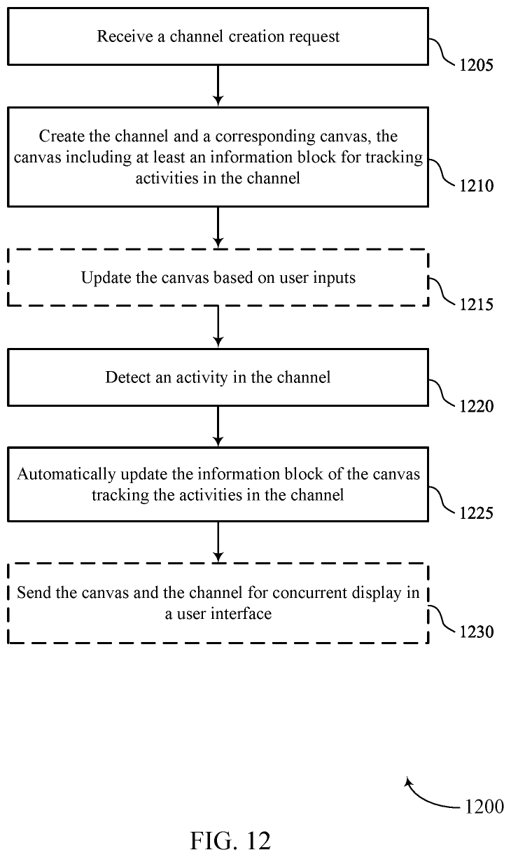

FIG. 12 shows a flowchart illustrating a method 1200 that supports automatic canvas creation associated with a group-based communication channel in accordance with aspects of the present disclosure. The operations of the method 1200 may be implemented by a group-based communication platform or its components (e.g., a computing device, such as an application server, a database server, a cloud-based server or service, a worker server, a server cluster, a virtual machine, a container, or any combination of these or other computing devices) as described herein. For example, the operations of the method 1200 may be performed by a group-based communication platform as described with reference to FIGS. 1 through 10. In some examples, a group-based communication platform may execute a set of instructions to control the functional elements of the group-based communication platform to perform the described functions. Additionally or alternatively, the group-based communication platform may perform aspects of the described functions using special-purpose hardware.

At 1205, the method may include receiving a channel creation request. For example, the method may involve receiving a request to create a channel in a group-based communication system. The operations of 1205 may be performed in accordance with examples as disclosed herein. In some examples, aspects of the operations of 1205 may be performed by a channel creation component 925 as described with reference to FIG. 9.

At 1210, the method may include creating the channel and a corresponding canvas, where the canvas includes at least an information block for tracking activities in the channel. For example, the method may involve—in response to the request—generating the channel in the group-based communication system, wherein the channel comprises a canvas associated with the channel and a plurality of objects comprising at least information associated with a sequential listing of messages for the channel, the canvas comprising a plurality of information blocks associated with the channel and auto-generated based at least in part on generating the channel, wherein the plurality of information blocks comprises at least an information block configured to track activity associated with the plurality of objects in the channel. The operations of 1210 may be performed in accordance with examples as disclosed herein. In some examples, aspects of the operations of 1210 may be performed by a canvas association component 930 as described with reference to FIG. 9.

At 1215, the method may include updating the canvas based on one or more user inputs. For example, the method may involve receiving a user input to add, modify, or remove an information block associated with the canvas. In some cases, the canvas may be directly editable by multiple users having access to the channel, the canvas, or both. The operations of 1215 may be performed in accordance with examples as disclosed herein. In some examples, aspects of the operations of 1215 may be performed by a canvas association component 930 as described with reference to FIG. 9.

At 1220, the method may include detecting an activity in the channel. For example, the method may involve detecting a change to an object of the plurality of objects in the channel. In some examples, the canvas may track a specific subset of activities, and the method may further involve determining that the detected activity corresponds to the subset of activities configured for tracking. The operations of 1220 may be performed in accordance with examples as disclosed herein. In some examples, aspects of the operations of 1220 may be performed by an activity detection component 935 as described with reference to FIG. 9.

At 1225, the method may include automatically updating the information block of the canvas tracking the activities in the channel. For example, the method may involve—in response to detecting the change—updating the information block configured to track the activity associated with the plurality of objects to reflect the detected change to the object. The operations of 1225 may be performed in accordance with examples as disclosed herein. In some examples, aspects of the operations of 1225 may be performed by an activity tracking component 940 as described with reference to FIG. 9.

At 1230, the method may include sending the canvas and the channel for concurrent display in a user interface. For example, the method may involve causing display of the canvas associated with the channel to be updated based at least in part on the updated information block. In some examples, the method may involve sending, for concurrent display in a user interface of a user device, the canvas and the sequential listing of messages for the channel. The operations of 1230 may be performed in accordance with examples as disclosed herein. In some examples, aspects of the operations of 1230 may be performed by a display component 945 as described with reference to FIG. 9.

A method for creating a channel-specific canvas is described. The method may include receiving a request to create a channel in a group-based communication system, in response to the request, generating the channel in the group-based communication system, wherein the channel comprises a canvas associated with the channel and a plurality of objects comprising at least information associated with a sequential listing of messages for the channel, the canvas comprising a plurality of information blocks associated with the channel and auto-generated based at least in part on generating the channel, wherein the plurality of information blocks comprises at least an information block configured to track activity associated with the plurality of objects in the channel, detecting a change to an object of the plurality of objects in the channel, and in response to detecting the change, updating the information block configured to track the activity associated with the plurality of objects to reflect the detected change to the object and causing display of the canvas associated with the channel to be updated based at least in part on the updated information block.

An apparatus for creating a channel-specific canvas is described. The apparatus may include a processor, memory coupled with the processor, and instructions stored in the memory. The instructions may be executable by the processor to cause the apparatus to receive a request to create a channel in a group-based communication system, in response to the request, generate the channel in the group-based communication system, wherein the channel comprises a canvas associated with the channel and a plurality of objects comprising at least information associated with a sequential listing of messages for the channel, the canvas comprising a plurality of information blocks associated with the channel and auto-generated based at least in part on generating the channel, wherein the plurality of information blocks comprises at least an information block configured to track activity associated with the plurality of objects in the channel, detect a change to an object of the plurality of objects in the channel, and in response to detect the change, updating the information block configured to track the activity associated with the plurality of objects to reflect the detected change to the object and causing display of the canvas associated with the channel to be updated based at least in part on the updated information block.

Another apparatus for creating a channel-specific canvas is described. The apparatus may include means for receiving a request to create a channel in a group-based communication system, means for in response to the request, generating the channel in the group-based communication system, wherein the channel comprises a canvas associated with the channel and a plurality of objects comprising at least information associated with a sequential listing of messages for the channel, the canvas comprising a plurality of information blocks associated with the channel and auto-generated based at least in part on generating the channel, wherein the plurality of information blocks comprises at least an information block configured to track activity associated with the plurality of objects in the channel, means for detecting a change to an object of the plurality of objects in the channel, and means for in response to detecting the change, updating the information block configured to track the activity associated with the plurality of objects to reflect the detected change to the object and causing display of the canvas associated with the channel to be updated based at least in part on the updated information block.

A non-transitory computer-readable medium storing code for creating a channel-specific canvas is described. The code may include instructions executable by a processor to receive a request to create a channel in a group-based communication system, in response to the request, generate the channel in the group-based communication system, wherein the channel comprises a canvas associated with the channel and a plurality of objects comprising at least information associated with a sequential listing of messages for the channel, the canvas comprising a plurality of information blocks associated with the channel and auto-generated based at least in part on generating the channel, wherein the plurality of information blocks comprises at least an information block configured to track activity associated with the plurality of objects in the channel, detect a change to an object of the plurality of objects in the channel, and in response to detect the change, updating the information block configured to track the activity associated with the plurality of objects to reflect the detected change to the object and causing display of the canvas associated with the channel to be updated based at least in part on the updated information block.

In some examples of the method, apparatuses, and non-transitory computer-readable medium described herein, the plurality of information blocks comprises text, an object, a file, an image, an audio recording, a video recording, a document, a bookmarks section, a related channels section, or any combination thereof.

In some examples of the method, apparatuses, and non-transitory computer-readable medium described herein, the canvas may be directly editable by a plurality of users accessing the channel. In some examples of the method, apparatuses, and non-transitory computer-readable medium described herein, the plurality of users comprises members of the channel.

Some examples of the method, apparatuses, and non-transitory computer-readable medium described herein may further include operations, features, means, or instructions for sending, for concurrent display in a user interface of a user device, the canvas and the sequential listing of messages for the channel. In some examples of the method, apparatuses, and non-transitory computer-readable medium described herein, the canvas may be displayed in a sidebar of the user interface and the sequential listing of messages for the channel may be concurrently displayed in a central pane of the user interface.

In some examples of the method, apparatuses, and non-transitory computer-readable medium described herein, the canvas further comprises a preview of an object associated with the channel.

In some examples of the method, apparatuses, and non-transitory computer-readable medium described herein, the canvas further comprises at least a portion of a workflow associated with the channel and the method, apparatuses, and non-transitory computer-readable medium may include further operations, features, means, or instructions for sending, for display in a user interface of a user device, the canvas comprising one or more triggers associated with the workflow, receiving a user input from the user interface corresponding to at least one trigger of the one or more triggers associated with the workflow, and in response to receiving the user input, performing the one or more processes of the workflow based at least in part on the at least one trigger.

In some examples of the method, apparatuses, and non-transitory computer-readable medium described herein, the canvas further comprises a data object associated with the channel and the method, apparatuses, and non-transitory computer-readable medium may include further operations, features, means, or instructions for accessing, from the canvas, the data object in a database system and sending, for display in a user interface of a user device, the canvas comprising data corresponding to the data object based at least in part on accessing the data object in the database system.

Some examples of the method, apparatuses, and non-transitory computer-readable medium described herein may further include operations, features, means, or instructions for receiving a user input from the user interface modifying at least a portion of the data corresponding to the data object within the canvas and in response to the user input, accessing the database system to modify one or more data objects in the database system to reflect at least the modified portion of the data.

In some examples of the method, apparatuses, and non-transitory computer-readable medium described herein, the database system comprises a multi-tenant database system and the data corresponding to the data object may be associated with standard data objects for a plurality of tenants of the database system, custom data objects associated with a tenant of the plurality of tenants of the database system, or a combination thereof.

Some examples of the method, apparatuses, and non-transitory computer-readable medium described herein may further include operations, features, means, or instructions for receiving a user input pinning a message, a file, or both from the sequential listing of messages to the canvas and in response to receiving the user input, updating the canvas to comprise a pin corresponding to the message, the file, or both and causing display of the canvas associated with the channel to be updated based at least in part on the pin.

Some examples of the method, apparatuses, and non-transitory computer-readable medium described herein may further include operations, features, means, or instructions for receiving a user input bookmarking a message, a file, or both from the sequential listing of messages at the canvas and in response to receiving the user input, updating the canvas to comprise a bookmark linking to the message, the file, or both and causing display of the canvas associated with the channel to be updated based at least in part on the bookmark.

Some examples of the method, apparatuses, and non-transitory computer-readable medium described herein may further include operations, features, means, or instructions for receiving an additional user input selecting the bookmark from the canvas and in response to receiving the additional user input, updating a display of the sequential listing of messages to display the message, the file, or both based at least in part on the bookmark linking to the message, the file, or both.

Some examples of the method, apparatuses, and non-transitory computer-readable medium described herein may further include operations, features, means, or instructions for receiving an update to one or more first access parameters for the channel and in response to receiving the update to the one or more first access parameters for the channel, updating one or more second access parameters for the canvas based at least in part on the updated one or more first access parameters.

Some examples of the method, apparatuses, and non-transitory computer-readable medium described herein may further include operations, features, means, or instructions for sending, for display in a user interface of a user device associated with a user, at least a portion of the canvas based at least in part on the user not being a member of the channel, wherein the portion of the canvas comprises a subset of information associated with the channel, the canvas, or both. In some examples of the method, apparatuses, and non-transitory computer-readable medium described herein, the subset of information comprises highlights of the channel based at least in part on a security parameter associated with the channel.

In some examples of the method, apparatuses, and non-transitory computer-readable medium described herein, the canvas further comprises one or more tasks, one or more actions, one or more assignable objects, or a combination thereof associated with the channel. In some examples of the method, apparatuses, and non-transitory computer-readable medium described herein, a display format of the canvas may be organized according to one or more tabs, one or more folders, one or more bookmarks, or a combination thereof. In some examples of the method, apparatuses, and non-transitory computer-readable medium described herein, the canvas further comprises one or more stacks and a stack of the one or more stacks may be a container comprising data associated with one or more data types grouped together in the stack.

The following provides an overview of aspects of the present disclosure:

Aspect 1: A method for creating a channel-specific canvas, comprising: receiving a request to create a channel in a group-based communication system; in response to the request, generating the channel in the group-based communication system, wherein the channel comprises a canvas associated with the channel and a plurality of objects comprising at least information associated with a sequential listing of messages for the channel, the canvas comprising a plurality of information blocks associated with the channel and auto-generated based at least in part on generating the channel, wherein the plurality of information blocks comprises at least an information block configured to track activity associated with the plurality of objects in the channel; detecting a change to an object of the plurality of objects in the channel; in response to detecting the change, updating the information block configured to track the activity associated with the plurality of objects to reflect the detected change to the object; and causing display of the canvas associated with the channel to be updated based at least in part on the updated information block.

Aspect 2: The method of aspect 1, wherein the plurality of information blocks comprises text, an object, a file, an image, an audio recording, a video recording, a document, a bookmarks section, a related channels section, or any combination thereof.

Aspect 3: The method of any of aspects 1 through 2, wherein the canvas is directly editable by a plurality of users accessing the channel.

Aspect 4: The method of aspect 3, wherein the plurality of users comprises members of the channel.

Aspect 5: The method of any of aspects 1 through 4, further comprising: sending, for concurrent display in a user interface of a user device, the canvas and the sequential listing of messages for the channel.

Aspect 6: The method of aspect 5, wherein the canvas is displayed in a sidebar of the user interface and the sequential listing of messages for the channel is concurrently displayed in a central pane of the user interface.

Aspect 7: The method of any of aspects 1 through 6, wherein the canvas further comprises a preview of an object associated with the channel.

Aspect 8: The method of any of aspects 1 through 7, wherein the canvas further comprises at least a portion of a workflow associated with the channel, the workflow comprising one or more processes to perform, the method further comprising: sending, for display in a user interface of a user device, the canvas comprising one or more triggers associated with the workflow; receiving a user input from the user interface corresponding to at least one trigger of the one or more triggers associated with the workflow; and in response to receiving the user input, performing the one or more processes of the workflow based at least in part on the at least one trigger.

Aspect 9: The method of any of aspects 1 through 8, wherein the canvas further comprises a data object associated with the channel, the method further comprising: accessing, from the canvas, the data object in a database system; and sending, for display in a user interface of a user device, the canvas comprising data corresponding to the data object based at least in part on accessing the data object in the database system.

Aspect 10: The method of aspect 9, further comprising: receiving a user input from the user interface modifying at least a portion of the data corresponding to the data object within the canvas; and in response to the user input, accessing the database system to modify one or more data objects in the database system to reflect at least the modified portion of the data.

Aspect 11: The method of any of aspects 9 through 10, wherein the database system comprises a multi-tenant database system; and the data corresponding to the data object is associated with standard data objects for a plurality of tenants of the database system, custom data objects associated with a tenant of the plurality of tenants of the database system, or a combination thereof.

Aspect 12: The method of any of aspects 1 through 11, further comprising: receiving a user input pinning a message, a file, or both from the sequential listing of messages to the canvas; and in response to receiving the user input, updating the canvas to comprise a pin corresponding to the message, the file, or both and causing display of the canvas associated with the channel to be updated based at least in part on the pin.

Aspect 13: The method of any of aspects 1 through 12, further comprising: receiving a user input bookmarking a message, a file, or both from the sequential listing of messages at the canvas; and in response to receiving the user input, updating the canvas to comprise a bookmark linking to the message, the file, or both and causing display of the canvas associated with the channel to be updated based at least in part on the bookmark.

Aspect 14: The method of aspect 13, further comprising: receiving an additional user input selecting the bookmark from the canvas; and in response to receiving the additional user input, updating a display of the sequential listing of messages to display the message, the file, or both based at least in part on the bookmark linking to the message, the file, or both.

Aspect 15: The method of any of aspects 1 through 14, further comprising: receiving an update to one or more first access parameters for the channel; and in response to receiving the update to the one or more first access parameters for the channel, updating one or more second access parameters for the canvas based at least in part on the updated one or more first access parameters.

Aspect 16: The method of any of aspects 1 through 15, further comprising: sending, for display in a user interface of a user device associated with a user, at least a portion of the canvas based at least in part on the user not being a member of the channel, wherein the portion of the canvas comprises a subset of information associated with the channel, the canvas, or both.

Aspect 17: The method of aspect 16, wherein the subset of information comprises highlights of the channel based at least in part on a security parameter associated with the channel.

Aspect 18: The method of any of aspects 1 through 17, wherein the canvas further comprises one or more tasks, one or more actions, one or more assignable objects, or a combination thereof associated with the channel.

Aspect 19: The method of any of aspects 1 through 18, wherein a display format of the canvas is organized according to one or more tabs, one or more folders, one or more bookmarks, or a combination thereof.

Aspect 20: The method of any of aspects 1 through 19, wherein the canvas further comprises one or more stacks, a stack of the one or more stacks is a container comprising data associated with one or more data types grouped together in the stack.

Aspect 21: An apparatus for creating a channel-specific canvas, comprising a processor; memory coupled with the processor; and instructions stored in the memory and executable by the processor to cause the apparatus to perform a method of any of aspects 1 through 20.

Aspect 22: An apparatus for creating a channel-specific canvas, comprising at least one means for performing a method of any of aspects 1 through 20.

Aspect 23: A non-transitory computer-readable medium storing code for creating a channel-specific canvas, the code comprising instructions executable by a processor to perform a method of any of aspects 1 through 20.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”′) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for creating a channel-specific canvas, comprising:
receiving a request to create a channel in a group-based communication system;
in response to the request, generating the channel in the group-based communication system, wherein the channel comprises a canvas associated with the channel and a plurality of objects comprising at least information associated with a sequential listing of messages for the channel;
in response to generating the channel, automatically generating the canvas associated with the channel, the canvas comprising a plurality of information blocks associated with the channel and auto-generated based at least in part on generating the channel, wherein the plurality of information blocks comprises at least an information block configured to track activity associated with the plurality of objects in the channel, and wherein the plurality of information blocks is arrangeable by a plurality of users accessing the channel;
receiving a first user input providing a summary description of the channel;
updating a channel summary for the channel to comprise the summary description based at least in part on the first user input;
sending, for concurrent display in a user interface of a user device, the sequential listing of messages for the channel in a central pane of the user interface and the canvas associated with the channel, comprising at least the channel summary for the channel, for display in a sidebar of the user interface;
receiving, via a search bar of the user interface, a second user input comprising a query;
identifying, in response to the query, a set of search results based at least in part on weighting first results corresponding to summary descriptions of channels relatively more than second results corresponding to messages in the channels; and
sending, for display in the user interface, the identified set of search results.

2. The method of claim 1, wherein the plurality of information blocks comprises text, a data object, a file, an image, an audio recording, a video recording, a document, a bookmarks section, a related channels section, or any combination thereof.

3. The method of claim 1, wherein the canvas is directly editable by the plurality of users accessing the channel.

4. (canceled)

5. The method of claim 1, wherein the canvas further comprises a preview of a first object associated with the channel.

6. The method of claim 1, wherein the canvas further comprises at least a portion of a workflow associated with the channel, the workflow comprising one or more processes to perform, the method further comprising:
sending, for display in the user interface of the user device, the canvas comprising one or more triggers associated with the workflow;
receiving a third user input via the user interface corresponding to at least one trigger of the one or more triggers associated with the workflow; and
in response to receiving the third user input, performing the one or more processes of the workflow based at least in part on the at least one trigger.

7. The method of claim 1, wherein the canvas further comprises a data object associated with the channel, the method further comprising:
accessing, from the canvas, the data object in a database system; and
sending, for display in the user interface of the user device, the canvas comprising data corresponding to the data object based at least in part on accessing the data object in the database system.

8. An apparatus for creating a channel-specific canvas, comprising:
a processor;
memory coupled with the processor; and
instructions stored in the memory and executable by the processor to cause the apparatus to:
receive a request to create a channel in a group-based communication system;
in response to the request, generate the channel in the group-based communication system, wherein the channel comprises a canvas associated with the channel and a plurality of objects comprising at least information associated with a sequential listing of messages for the channel;
in response to generating the channel, automatically generate the canvas associated with the channel, the canvas comprising a plurality of information blocks associated with the channel and auto-generated based at least in part on generating the channel, wherein the plurality of information blocks comprises at least an information block configured to track activity associated with the plurality of objects in the channel, and wherein the plurality of information blocks is arrangeable by a plurality of users accessing the channel;
receive a first user input providing a summary description of the channel:
update a channel summary for the channel to comprise the summary description based at least in part on the first user input;
send, for concurrent display in a user interface of a user device, the sequential listing of messages for the channel in a central pane of the user interface and the canvas associated with the channel, comprising at least the channel summary for the channel, for display in a sidebar of the user interface;
receive, via a search bar of the user interface, a second user input comprising a query;
identify, in response to the query, a set of search results based at least in part on weighting first results corresponding to summary descriptions of channels relatively more than second results corresponding to messages in the channels; and
send, for display in the user interface, the identified set of search results.

9. The apparatus of claim 8, wherein the plurality of information blocks comprises text, a data object, a file, an image, an audio recording, a video recording, a document, a bookmarks section, a related channels section, or any combination thereof.

10. The apparatus of claim 8, wherein the canvas is directly editable by the plurality of users accessing the channel.

11. (canceled)

12. The apparatus of claim 8, wherein the canvas further comprises a preview of a first object associated with the channel.

13. The apparatus of claim 8, wherein the canvas further comprises at least a portion of a workflow associated with the channel, the workflow comprising one or more processes to perform, and the instructions are further executable by the processor to cause the apparatus to:
send, for display in the user interface of the user device, the canvas comprising one or more triggers associated with the workflow;
receive a third user input via the user interface corresponding to at least one trigger of the one or more triggers associated with the workflow; and
in response to receiving the third user input, perform the one or more processes of the workflow based at least in part on the at least one trigger.

14. The apparatus of claim 8, wherein the canvas further comprises a data object associated with the channel, and the instructions are further executable by the processor to cause the apparatus to:
access, from the canvas, the data object in a database system; and
send, for display in the user interface of the user device, the canvas comprising data corresponding to the data object based at least in part on accessing the data object in the database system.

15. A non-transitory computer-readable medium storing code for creating a channel-specific canvas, the code comprising instructions executable by a processor to:
receive a request to create a channel in a group-based communication system;
in response to the request, generate the channel in the group-based communication system, wherein the channel comprises a canvas associated with the channel and a plurality of objects comprising at least information associated with a sequential listing of messages for the channel;
in response to generating the channel, automatically generate the canvas associated with the channel, the canvas comprising a plurality of information blocks associated with the channel and auto-generated based at least in part on generating the channel, wherein the plurality of information blocks comprises at least an information block configured to track activity associated with the plurality of objects in the channel, and wherein the plurality of information blocks is arrangeable by a plurality of users accessing the channel;
receive a first user input providing a summary description of the channel;
update a channel summary for the channel to comprise the summary description based at least in part on the first user input;
send, for concurrent display in a user interface of a user device, the sequential listing of messages for the channel in a central pane of the user interface and the canvas associated with the channel, comprising at least the channel summary for the channel, for display in a sidebar of the user interface;
receive, via a search bar of the user interface, a second user input comprising a query;
identify, in response to the query, a set of search results based at least in part on weighting first results corresponding to summary descriptions of channels relatively more than second results corresponding to messages in the channels; and
send, for display in the user interface, the identified set of search results.

16. The non-transitory computer-readable medium of claim 15, wherein the plurality of information blocks comprises text, a data object, a file, an image, an audio recording, a video recording, a document, a bookmarks section, a related channels section, or any combination thereof.

17. The non-transitory computer-readable medium of claim 15, wherein the canvas is directly editable by the plurality of users accessing the channel.

18. (canceled)

19. The non-transitory computer-readable medium of claim 15, wherein the canvas further comprises at least a portion of a workflow associated with the channel, the workflow comprising one or more processes to perform, and the instructions are further executable by the processor to:
send, for display in the user interface of the user device, the canvas comprising one or more triggers associated with the workflow;
receive a third user input via the user interface corresponding to at least one trigger of the one or more triggers associated with the workflow; and
in response to receiving the third user input, perform the one or more processes of the workflow based at least in part on the at least one trigger.

20. The non-transitory computer-readable medium of claim 15, wherein the canvas further comprises a data object associated with the channel, and the instructions are further executable by the processor to:
access, from the canvas, the data object in a database system; and
send, for display in the user interface of the user device, the canvas comprising data corresponding to the data object based at least in part on accessing the data object in the database system.

21. The method of claim 7, further comprising:
receiving a fourth user input via the user interface modifying at least a portion of the data corresponding to the data object within the canvas; and
in response to the fourth user input, accessing the database system to modify one or more data objects in the database system to reflect at least the modified portion of the data.

22. The method of claim 7, wherein:
the database system comprises a multi-tenant database system; and
the data corresponding to the data object is associated with standard data objects for a plurality of tenants of the database system, custom data objects associated with a tenant of the plurality of tenants of the database system, or a combination thereof.

23. The method of claim 1, further comprising:
receiving a fifth user input pinning a message, a file, or both from the sequential listing of messages to the canvas; and
in response to receiving the fifth user input, updating the canvas to comprise a pin corresponding to the message, the file, or both and causing display of the canvas associated with the channel to be updated based at least in part on the pin.
